(19) United States
(12) Patent Application Publication
(10) Pub. No.: US 2022/0391795 A1
(43) Pub. Date: Dec. 8, 2022

(54) SYSTEM AND METHOD FOR RISK ASSESSMENT

(71) Applicant: ALYNE GMBH, München (DE)

(72) Inventors: Karl VIERTEL, München (DE); Manuel REIL, München (DE); Matthias DANNER, München (DE); Stefan SULISTYO, München (DE)

(73) Assignee: ALYNE GMBH, München (DE)

(21) Appl. No.: 17/775,232

(22) PCT Filed: Nov. 5, 2020
(86) PCT No.: PCT/EP2020/081178

§ 371 Date: May 6, 2022

(30) Foreign Application Priority Data
Nov. 7, 2019 (EP) 19207749.3
Nov. 7, 2019 (EP) 19207760.0

(51) Int. Cl. G06Q 10/06

(52) U.S. Cl. CPC G06Q 10/0635

(57) ABSTRACT

The present invention is directed to a system, comprising a first data-processing system and at least one second data-processing system. The system further comprises a processing component and a data-storage component. The system is configured to perform for each condition-state of a subset of condition states the following operations: Comparing each condition-state value and a respective condition-state threshold, thus generating a comparison result for each of these condition-states, and further assigning each comparison result to the respective condition-state. The invention is furthermore directed to a corresponding computer-implemented method.

### FIELD

The invention relates to a system for risk assessment and risk management for various systems and environments and a corresponding method.

### BACKGROUND

Nowadays, for many systems, risks are assessed in all lifecycle phases: For example, in the design phase of most complex technical systems, such as motor vehicles, aircrafts and ships, risks of certain incidents are assessed. In consequence, for example, measures to reduce a risk of occurrence of said incidents or measures to reduce an impact of an occurrence of said incidents can be taken. Very common methods to manage such risks is the Failure Mode and Effects Analysis (FMEA) as well as the Failure Mode, Effects and Criticality Analysis (FMECA)—both are often referred to as FMEA.

The same applies for the operation of technical systems, for example chemical processing plants or manufacturing plants. For example for the determining a need of preventive maintenance, effects resulting from failure (or a detectable state of degradation) are assessed. These effects can be harm for operators and/or an environment, for example if an air filtering system or a safety device fail. But they can also be related to effects on a productivity of a part of the system or depending systems. For example, a stoppage of a machine can lead to a production stop for subsequent and/or preceding line parts, in particular in the context of LEAN production.

Risk assessment and risk management can be required by law or regulation. Depending on outcomes of risk assessments and/or implemented counter measures, requirements can be made. This even applies to financial service providers such as banks or insurances, which may be obligated to have a certain financial backup depending on risks that result from their operation. This backup can further depend on which measures they take in order to mitigate risks.

Risk management also plays an important role in the operation of water craft. Apart from interests of shipowners and the crew to keep a vessel in safe operation, international contracts and guidelines such as the contracts negotiated under the aegis of IMO require several safety measures to limit risks result from operating vessels.

However, often, said risk management is still performed manually. Software solutions often only transpose a process from paper to software—however, the assessment of risks, their agglomeration and the management of dependencies often stays a human task. In consequence, problems such as a low reproducibility of results of such analyses as well as false estimations because of human perception of risks are still a common problem. Furthermore, many risk management systems lack flexibility, especially when they are implemented in spreadsheets that are relatively rigid in terms of structure of dependencies.

Also, understanding complex interactions between risks is cognitively cumbersome for humans. Thus, finding synergies or common origins of risks with a multitude of dependencies can be non-obvious.

### SUMMARY

It is therefore an object of the invention to overcome or at least alleviate the shortcomings and disadvantages of the prior art.

More particularly, it is an object of the present invention to provide an improved system and method for supporting risk management.

This objective is met by a system comprising a first data-processing system and at least one second data-processing system.

The first data-processing system can comprise a server. The first data-processing system can also comprise a cloud-computing system. The first data-processing system can comprise a computing power that is bigger than a computing power of the second data-processing system.

The first data-processing system can be distributed or central. The first data-processing system can be stationary.

The second data-processing system can comprise at least one or a plurality of end-user computer devices, such as smart phones, laptops, tablet computers, and/or terminal computers.

The second data-processing system can be distributed.

The system can be configured for processing data. That is, the system can be configured to treat data according to instructions. The system can comprise components that are necessary to perform said processing, such as processing at least one processing unit(s) and at least one memory unit(s).

The system can be configured for storing data. That is, the system can be configured for storing data temporarily or permanently. The system can be configured to store the data in a machine-readable form.

The system can be configured for receiving input data. The input data can comprise data from data processing systems that are connected to the system, for example via internet and/or a local network. The input data can comprise user input data from one or more users.

The input data can comprise data from sensing devices.

The system can be configured for transmitting data. The system can more specifically be configured for transmitting data to another data processing system. The system can also be configured for transmitting data between different parts of said system, for example a part of the first and a part of the second data processing system.

The system can comprise a processing component. The processing component can be configured to process data. The processing component can comprise one or a plurality of processing units, such as CPU(s) of one or more computer devices. The processing component can comprise a portion of the first data-processing, a portion the second data processing system and/or a portion of the first data-processing system and a portion of the second data-processing system.

The system can further comprise a data-storage component. The data-storage component can comprise at least one or a plurality of data-storage units. The data-storage component can be configured for storing data in a machine-readable way. The data-storage component can further be configured for storing data in a computer-readable way.

The second-data processing system can be configured for transmitting data to the first data-processing system.

The second-data processing system can further be configured to receive input data from at least one of a document-sensing unit, a data storage device and/or a user input.

An advantage of this embodiment may be that said input data can be made available to the first data-processing system.

The document-sensing unit can comprise a scanner, a camera or another sensing unit configured to sense documents. The document-sensing unit can be configured for detecting a content of a document. The document-sensing unit can also be configured for sensing features relating to an authenticity of a document. The document-sensing unit can be configured to sense further data and/or features.

The second data-processing system can be configured to receive data from the first data-processing system.

The second data-processing system can comprise a user interface that is configured to output said data that second data-processing system received from the first data-processing system to the at least one or more user(s).

The second data-processing system can comprise at least a portion of at least one or a plurality of end-user computer device(s). That is, the second data-processing system can comprise at least a portion of at least one end-user computer device or portions of each of a plurality of end-user computer devices. That can for example be the case when the second data-processing system comprises end user computer system with profiles for a plurality of users, and at least one profile belongs to a second data-processing system “A” and at least another profile belongs to a second data-process system “B”.

The second data-processing system can also be the plurality of end-user computer devices. The first data-processing system can be configured for transmitting data to at least a portion of the second data-processing system.

The first data-processing system can further be configured for receiving data from at least a portion of the second data-processing system.

An advantage of these embodiments can be that tasks that require input data acquired by the second data-processing system can be performed by the first data-processing system and that the results can be outputted by the second data-processing system. This can obviously also be advantageous in cases where the first data-processing system transmits data that facilitate solving said tasks to the second data-processing system.

The first data-processing system can be configured for transmitting data to a third data-processing system. The third data-processing system can be connected to the first data-processing system. The third data-processing system can also be connected to the system. The third data-processing system can be connected to the system and/or the first data-processing system via internet and/or a local network connection.

An advantage can be that results of operations carried out by the system can directly be transmitted to a third data-processing system.

That can be advantageous when said results are machine-readable, as they can then be directly processed by the third data-processing system and/or directly archived there in a machine-readable form.

The system can comprise a plurality of second data-processing systems. The first data-processing system can be configured to transmit data to and/or receive data from each of the second data-processing systems. That is, the first-data processing system can also be configured to transmit data to and/or receive data from portions of each of the second data-processing systems respectively.

The first data-processing system can further be configured for transmitting data to a plurality of third data processing systems.

The processing component can comprise a condition-state determining component. The condition-state determining component can be configured for determining data that are representative for at least one or a plurality of condition-state(s).

The at least one condition-state can be a state of a condition relating to a system or an organisation or a data-element representative for said condition. It can be a state of a condition which condition relates to measures to reduce, mitigate or otherwise influence risks, their consequences and/or their causes or triggers. Said condition-state can also be used to model a “control” in the language of risk management.

The processing component can further comprise a condition-state processing component. The condition-state processing component can be configured to process the data representative for the at least one or the plurality of condition-states(s).

The processing component can further comprise a condition-node processing component. The condition-node processing component can be configured for processing at least one or a plurality of condition-node(s). A condition-node can be representative of a certain event or incident. A condition-node can be representative of a risk that the incident occurs or that the certain state is reached.

The processing component can comprise an input-processing component. The input-processing component can be configured for processing input that the system or a portion thereof received.

Said input can be at least one of input from at one sensing device, user input data and data transmitted by the third data-processing system to the system and/or the first data-processing system.

The processing component can comprise an output-determining component. The output-determining component can be configured to determine data to be outputted and/or transmitted.

The system can comprise at least one user interface. The second data-processing system can comprise the at least one user interface. An advantage can be a simplified data input to the system, for example when the second data-processing system comprises end-user computer devices and the first data processing system is or comprises a cloud-computing system.

The processing component can comprise a pre-calculating component. The pre-calculating component can be configured to pre-calculate data. An advantage of pre-calculating data can be an improved response time of the system during runtime.

The output-determining component can comprise the condition-state determining component.

The output-determining component can comprise the condition-state processing component.

The output-determining component can comprise the condition-node processing component.

The output-determining component can comprise the input-processing component.

The data-storage component can be configured for storing a plurality of condition-nodes.

The data-storage component can further be configured for storing a plurality of condition-node modifiers, wherein each condition-node modifier can relate to a condition-node. The condition-node modifier can be a data element representative for an impact of all condition-states that impact a specific condition-node.

The data-storage component can further be configured for storing a plurality of condition-node values and wherein each condition-node comprises a condition-node value. A condition-node value can be representative of an estimate of a probability of occurrence of the certain event or incident. A condition-node can be representative of a measure of a risk that the incident occurs or the certain state is reached.

The data-storage component can be configured for storing at least one or a plurality of condition-states.

The data-storage component can further be configured for storing a plurality of assignments, wherein each assignment assigns a condition-state to at least one of the condition-nodes. An assignment can indicate that a condition-state impacts a condition-node. An assignment can further indicate that a condition-state impacts a condition-node value.

The data-storage component can further be configured for storing a plurality of condition-state thresholds. Each condition-state can comprise a condition-state threshold. A condition-state threshold can be a reference or a comparative value for a status of a condition-state.

The data-storage component can further be configured for storing a plurality of condition-state values and wherein each condition-state comprises a condition-state value. A condition-state value can be an indicator and/or a measure for a status of a condition-state.

The data-storage component can further be configured for storing a plurality of comparison results. Each condition-state can comprise a comparison result. A comparison-result can be an indicator for an impact and/or effectivity of a condition-state. A condition-node modifier can be a combination of the comparison-results of the condition-states assigned to the condition-node that comprises said condition-node modifier. Such a combination can for example be an average, a weighted average, a sum or a weighted sum.

The data-storage component can be further configured for storing at least one or a plurality of node-links. A node-link can link two condition-nodes. A node-link can be representative of a connection between conditions modelled by the condition-nodes. In a case where two condition-nodes each model a risk, a node-link can model the relation of the two risks, for example one risk increasing the other.

The node-links can further be directed. That is, in a case where node-link C links condition-nodes A and B in the direction from A to B, then B is reachable from A, but A is not reachable from B via the node-link C. The terms “directed” and “reachable” are intended to be understood in the way of terms of graph theory, interpreting the condition-nodes and node-links as a directed graph.

The resulting graph can furthermore be acyclic. The condition-nodes and the node-links can be connected so that such a resulting directed graph is acyclic.

The node-links can further satisfy a supplementary condition. The supplementary condition may be that the links do not form circles if they are directed.

The data-storage component can further be configured for storing a node-link value for each node-link. Each node-link can further comprise a node-link value. A node-link value can be a value representative of a weighting of a node-link or a data-element representative thereof.

The data-storage component can be configured for storing at least one or a plurality of subset(s) of the condition-nodes. The subset(s) of the condition-nodes can each comprise at least one or at least some of the condition-nodes. They can each comprise at most all of the condition-nodes.

The at least one or the plurality of condition-states can be a plurality of condition states. The data-storage component can be configured for storing at least one or a plurality of subset(s) of the condition-states. The subset(s) of the condition-states can each comprise at least one or at least some of the condition-states. They can each comprise at most all of the condition-states.

The at least one or the plurality of node-links can be a plurality of node-links. The data-storage component can be configured for storing at least one or a plurality of subset(s) of the node-links. The subset(s) of the node-links can each comprise at least one or at least some of the node-links. They can each comprise at most all of the node-links.

The system and/or the condition-state determining component can be configured to perform for each condition-state of at least a subset of the condition-states the following operations: The system and/or the condition-state determining component can be configured for comparing each condition-state value and the respective condition-state threshold in at least a subset of the condition-states. The system and/or the condition-state determining component can be configured for thus generating a comparison result for each of these condition-states. Furthermore, the system and/or the condition-state determining component can be configured for assigning the comparison result to the respective condition-state.

In other words, the system and/or the condition-state determining component can be configured for performing these steps for at least some of the condition-states, for example for a subset of the condition-states. The system and/or the condition-state determining component can also be configured for performing these steps for a plurality of subsets of the condition-states or for each of the condition-states.

The condition-state processing component and/or the system can be configured for generating a condition-node modifier for each condition-node of at least a subset of condition-nodes by aggregating the comparison results of the condition-states of at least a subset of condition-nodes which condition-states are assigned to the respective condition-node.

That is, the condition-state processing component and/or the system can be configured to combine the comparison results of all condition-states assigned to a condition-node and thus generate a condition-node modifier for said condition-node. The condition-state processing component and/or the system can furthermore be configured for performing this for some or all condition-nodes and the assigned condition-states or subsets of the assigned condition-states. The latter can be advantageous when only a subset of the condition-states is applicable.

The condition-state determining component and/or the system can be configured to compare the condition-state values and the condition-state thresholds of at least the subset of the condition-states by calculating a distance of each condition-state value and the respective condition-state threshold and to generate the respective comparison result based on this distance.

That is, the condition-state determining component and/or the system can be configured to generate comparison results by calculating a distance or a measure for a distance of condition-state values and respective condition-state thresholds.

Such a distance or measure thereof can for example be the difference of two scalar values.

The condition-state determining component and/or the system can further comprise a limiting element.

The limiting element can be configured to limit the comparison results to a certain range of values. For example, the limiting element can be configured to only keep negative or positive distances and to set the comparison result to 0 otherwise. This can be advantageous when condition-state values exceed the respective condition-state thresholds and when the condition-state thresholds model a required state of an implementation of a measure. In such a case, a condition-state value exceeding a condition-state threshold would mean that a measure is implemented beyond the requirement. Depending on an application of the system, it can be irrelevant “how much beyond the requirement” the measure is implemented.

The condition-node processing component and/or the system can be configured for generating a condition-node value for each condition-node of at least the subset of condition-nodes.

The condition-node processing component and/or the system can further be configured for assigning each condition-node value to the respective condition-node.

The system and/or the condition-node processing component can further be configured for combining for each condition-node of at least the subset of the condition-nodes the condition-node modifier of the respective condition-node and the condition-node values of all condition-nodes of the subset of condition-nodes which are respectively linked to the respective condition-node by a node-link that is directed towards the respective condition-node.

In other words, the system and/or the condition-node processing component can be configured to combine values of condition-nodes that are linked to a specific condition-node with a condition-node modifier belonging to the specific condition-node. The system and/or the condition-node processing component can further be configured to perform such an operation for some or all condition-nodes.

Said combining of values can for example be summing up or generating an average or weighted average of values.

The condition-node processing component and/or the system can further be configured for combining for each condition-node of at least the subset of the condition-nodes:
the condition-node modifier of the respective condition-node,
the condition-node values of all condition-nodes of the subset of condition-nodes which are respectively linked to the respective condition-node by a node-link that is directed towards the respective condition-node, and
the node-link values of the node-links connecting said condition-nodes.

The condition-node processing component and/or the system can also be configured for performing this operation for each of the condition-nodes.

The first data-processing system can comprise the condition-state determining component.

The first data-processing system can comprise the condition-state processing component.

The first data-processing system can comprise the condition-node processing component.

The system can be configured for receiving input data that indicate at least a part or all of the condition-states of the subset(s) of the condition-states.

The system can further be configured for storing the subset(s) of the condition-states according to the input data that indicate at least the part or all of the condition-states in said subset(s).

The input-processing component and/or the system can be configured for determining the subset(s) of the condition-states based on the input data that indicate at least a part or all of the condition-states of said subset(s).

The input data indicating at least the part or all of the condition-states of the subset(s) of condition-states can comprise at least one or a plurality of groups of condition-states.

The input processing component can be configured for merging the at least one or the plurality of groups of condition-states to obtain the subset(s) of the condition-states.

The second data-processing system can be configured to receive the input data that indicate at least a part or all of the condition-states of the subset(s) of the condition-states.

The system can be configured to for receiving input-data that indicate at least a part or all of the condition-nodes of the subset of the condition-nodes.

The data-storage component can be configured for storing the subset of the condition-nodes according to the received input data that indicate at least the part or all of the condition-nodes.

The input-processing component and/or the system can be configured for determining the subset(s) of the condition-nodes based on the input data that indicate at least a part or all of the condition-nodes of said subset(s).

The input data indicating at least the part or all of the condition-nodes of the subset(s) of condition-nodes can comprise at least one or a plurality of groups of condition-nodes.

Furthermore, the input processing component and/or the system can be configured for merging the at least one or the plurality of groups of condition-nodes to obtain the subset(s) of the condition-nodes.

The second data-processing system can be configured to receive the input data that indicate at least a part or all of the condition-nodes of the subset(s) of the condition-states. This can be advantageous in cases where the second data-processing system is configured for receiving user input or when it comprises a user interface.

The input data that indicate at least a part or all of the condition-nodes of the subset(s) of the condition-states can comprise the input data that indicate at least a part or all of the condition-states of the subset(s) of the condition-states.

The input processing component and/or the system can be configured for determining the subset(s) of the condition-nodes based on the input data that indicate at least a part or all of the condition-states of the subset(s) of the condition-states.

The system can further be configured for receiving input data that indicate at least a part or all of the node-links of the subset(s) of the node-links.

The data storage component can be configured to store the subset(s) of the node-links indicated by the input data indicating said subset(s).

The system and/or the input-processing component can be configured for determining the subset(s) of the node-links based on the input data that indicate at least a part or all of the node-links of said subset(s).

The input data indicating at least the part or all of the node-links of the subset(s) of the node-links can comprise at least one or a plurality of groups of node-links.

The input processing component and/or the system is configured for merging the at least one or the plurality of groups of node-links to obtain the subset(s) of the node-links.

The second data-processing system can be configured to receive the input data that indicate at least a part or all of the node-links of the subset(s) of the node-links.

The system can further be configured for receiving input data that indicate at least a part or all of the condition-state values.

The system can further be configured for receiving at least a portion of the input data that indicate at least a part or all of the condition-state values from a data-processing system.

The system can be configured for receiving at least a portion of the input data that indicate at least a part or all of the condition-state values from at least one or a plurality of sensing devices.

The system can be configured for outputting data.

The system can be configured for outputting condition-node values of the condition-nodes.

The system can further be configured for outputting node-links that link the condition-nodes.

The system can also be configured for outputting comparison results of the condition-states.

The system can also be configured for outputting condition-node values of the condition-nodes of the subset(s) of condition-nodes.

The system can be configured for outputting node-links linking the condition-nodes of the subset(s) of the condition-nodes.

The system can be configured for outputting comparison results of the condition-states of the subset(s) of the condition-states.

The system can be configured for outputting at least a portion or all of the data to be outputted to at least one of the at least one user interface.

The second data-processing system can be configured for transmitting at least a portion or all of the data to be outputted to the at least one of the at least one user interface.

The second data-processing system can be configured for processing at least a portion or all of the data to be outputted.

The system can be configured for outputting at least a portion or all of the data to be outputted by transmitting them to a third data-processing system.

The first data-processing system can also be configured to transmit said at least the portion or all of the data to be outputted.

The data to be outputted can comprise at least one of condition-nodes and condition-states that are linked by one or more node-links to at least one of a specified condition-node and a specified condition-state.

The system can be configured for determining said at least one of condition-nodes and condition-states that are linked by one or more node-links to at least one of a specified condition-node and a specified condition-state.

The output-determining component can be configured for determining said at least one of condition-nodes and condition-states that are linked by one or more node-links to at least one of a specified condition-node and a specified condition-state.

The data to be outputted can comprise at least one of condition-nodes and condition-states to be outputted that are each linked to at least one of a specified condition-node and a specified condition-state according to at least one of at least one or a plurality of linking criteria.

The term linking criterion are intended to refer to a criterion that is based on one or more characteristics of a connection, link and/or reference from a specified element such as the specified condition-node and/or the specified condition-state to another element such as another condition-state or another condition state.

The output-determining component can be configured for determining at least one of condition-nodes and condition-states to be outputted that are each linked to at least one of a specified condition-node and a specified condition-state.

The data to be outputted can comprise the data determined by the output-determining component.

The data to be outputted can be the data that are or will be outputted by the system or one of its elements. The data to be outputted can be data which the system is configured to output.

The system can be configured to output data determined by the output-determining component.

The output-determining component can be configured for determining condition-nodes to be outputted based on a specified condition-node, wherein the specified condition-node is reachable from each of the condition-nodes to be outputted by the node-links. The term reachable is to be understood in the sense as discussed above, that is in the context graph theory and directed, acyclic graphs, wherein a node-link is to be interpreted as link or edge and a condition-node is to be interpreted as vertex or node.

The output-determining component can be configured for determining condition-states to be outputted based on a specified condition-node. The output-determining component can be configured to determine the condition-states to be outputted based on whether they are assigned to the specified condition-node. An advantage may be that the system can provide a user with an overview of condition-states or measures represented by the condition-states which directly impact a condition-node or a risk represented by said condition-node. As an example, a user for whom such an overview can be beneficial is an engineer in charge of an operation of a manufacturing line whose task it is to reduce production losses due to stoppage or quality loss at one of the line's stations.

In other words, the output-determining component can be configured to determine which condition-states are assigned to the specified condition-node.

The output-determining component can also be configured to perform this operation of determining condition-states to be outputted based on the specified condition-node for each of a plurality of specified condition-nodes.

The output-determining component can be configured for determining condition-states to be outputted based on the specified condition-node, wherein each condition-state to be outputted is either assigned to the specified condition-node or assigned to a condition-node from which the specified condition-node is reachable by the node-links.

In other words, the output-determining component can also be configured to determine which condition-states are either assigned to the specified condition-node or to a condition-node from which the specified condition-node is reachable. In this case, the determined condition-states can be condition-states whose changes may impact the specified condition-node. An advantage may be that the system can provide a user with an overview of condition-states or measures represented by the condition-states which impact a condition-node or a risk represented by said condition-node at all. Another advantage may be that all condition-states that were not determined by the output-determining component may be not impacting the specified condition-node.

The output-determining component can also be configured to perform this operation of determining condition-states to be outputted based on the specified condition-node for each of a plurality of specified condition-nodes.

The output-determining component can be configured for determining condition-nodes to be outputted based on a specified condition-node, wherein each of the condition-nodes to be outputted is reachable from the specified condition-node by the node-links. That is, the output-determining component can be configured for determining all condition-nodes that are reachable from the specified condition-node. An advantage may be that the system can provide a user with an overview of condition-nodes or risks represented or modelled by these condition-nodes which are impacted by the specified condition-node or a risk represented or modelled by this condition-node.

The output-determining component can also be configured to perform this operation of determining condition-nodes to be outputted based on the specified condition-node for each of a plurality of specified condition-nodes.

The output-determining component can be configured for determining condition-nodes to be outputted based on a specified condition-state, wherein the specified condition-state is assigned to each of the condition-nodes to be outputted. That is, the output-determining component can be configured for outputting all condition-nodes to which the specified condition-state is assigned. An advantage can be that the system can provide a user with an overview of which condition-nodes or risks represented or modelled by said condition-nodes are impacted by the specified condition-state or measures represented or modelled by said specified condition-state.

The output-determining component can also be configured to perform this operation of determining condition-nodes to be outputted based on the specified condition-state for each of a plurality of specified condition-states.

The output-determining component can be configured for determining condition-nodes to be outputted based on a specified condition-state, wherein for each of the condition-nodes to be outputted, either the specified condition-state is assigned to said condition-node to be outputted, or the specified condition-state is assigned to a condition-node from which the respective condition-node to be outputted is reachable by the node-links. That is, the output-determining component can be configured for determining all condition-nodes to which the specified condition-state is assigned or to which node-links lead from a condition-node to which the specified condition-state is assigned. An advantage can be that the system can provide a user with an overview of all condition-nodes or risks represented or modelled by these condition-nodes that can be impacted by the specified condition-state or a measure represented or modelled thereby.

The output-determining component can also be configured to perform this operation of determining condition-nodes to be outputted based on the specified condition-state for each of a plurality of specified condition-states.

The output-determining component can furthermore be configured to determine the condition-nodes to be outputted from a specified subset of the condition-nodes. That is, the output-determining component can be configured to carry out the above-discussed operations also for a subset of the condition-nodes or for each of a plurality of subsets of the condition-nodes. An advantage can be that the system can be configured to only output relevant or applicable condition-nodes for a certain situation and/or a certain system, when the subset of the condition-nodes only comprises a part of the condition-nodes that corresponds to said situation and/or system.

The output-determining component can furthermore be configured to determine the condition-states to be outputted from a specified subset of the condition-states. That is, the output-determining component can be configured to carry out the above-discussed operations also for a subset of the condition-states or for each of a plurality of subsets of the condition-states.

The output-determining component can be configured to perform the determining for each of a plurality of subsets of condition-nodes and/or condition-states. That is, the output-determining component can be configured for the determining at least one of the condition-nodes and condition-states for each of a plurality of subsets of condition-nodes and/or each of a plurality of subsets of condition-states. The output-determining component can also be configured for determining the at least one of the condition-nodes and condition-states for a subset of the condition-nodes combined with a subset of the condition-states and/or for each of a plurality of these combinations.

That is, when the system stores a plurality of condition-states and/or condition-nodes, then the output-determining component can be configured to output only condition-states and/or condition-states belonging to a subset of the condition-states and/or a subset of the condition-nodes respectively.

This can be advantageous for example when the system stores condition-nodes and condition-states for different variations A, B and C of a system, wherein for the different variations, different subsets of the condition-nodes and/or condition-states are applicable. An example can be for example a system storing condition-nodes and condition-states for different types of ships, that, depending on the type of their cargo, can have different risks or measures that are applicable. An obvious example are different applicable condition-states and condition-nodes when the ship transports bulk cargo, vehicles, or intermodal containers (also referred to as “freight container” or “ISO container”). In such a case, risks and measures to be represented to obviously vary.

The output-determining component can be configured to perform the determining based on at least one of the specified condition-node and the specified condition-state for each of a plurality of specified condition-nodes and/or specified condition-states respectively. That is, the output-determining component can be configured to generate condition-states and/or condition-nodes to be outputted each of a plurality of subsets of the condition-nodes and/or condition-states. An advantage can be that the output-determining component does not need to be limited to one subset of condition-states and/or one subset of condition-nodes and that it can hence generate outputs for a plurality of applications.

The system can be configured to output the condition-nodes and/or the condition-states to be outputted.

The system can be configured to output the condition-nodes and/or the condition-states to be outputted ordered by a respective subset to which they belong.

The system can be configured to output the condition-nodes and/or the condition-states to be outputted ordered by a respective specified condition-state and/or condition-node based on which they were determined.

The system can be configured to output the condition-node values and/or the condition-state values corresponding to the condition-nodes and/or condition-states to be outputted.

The pre-calculating component can be configured for performing pre-calculations of for at least a portion of the data to be outputted and to thus generate pre-calculated data. For example, the pre-calculating component can be configured to pre-calculate data based on which the data to be outputted, such as the condition-nodes to be outputted and/or the condition-states to be outputted, can be determined. However, the pre-calculating component can also be configured to pre-calculate a portion of the data to be outputted.

The pre-calculating component can be configured for pre-calculating at least a portion of the at least one of the condition-nodes and the condition-states to be outputted that are each linked to at least one of a specified condition-node and a specified condition-state. For example, the pre-calculating component can be configured to pre-calculate data that the output-determining component is configured to determine.

Pre-calculating is intended to refer to performing a computing operation before its result is requested by a user. For example, the pre-calculating component can be configured for calculating condition-states that are assigned to specific condition-nodes for all condition-nodes or for each condition-node of at least one of the subsets of the condition-nodes before the user requests output of the condition-states that are assigned to one of the condition-nodes.

The pre-calculating component can be configured for pre-calculating the at least one of the condition-nodes and the condition-states to be outputted for a plurality of different specified condition-nodes and/or condition-states.

The pre-calculating component can be configured for pre-calculating the at least one of the condition-nodes and the condition-states to be outputted for each possible specified condition-nodes and/or condition-states.

An advantage of the pre-calculating component can be that a response of the system to a user-request can be faster at runtime. In other words, an advantage can be that the system can provide responses faster during runtime, as if the response would entirely be calculated on runtime.

The person ordinarily skilled in the art will understand that requests from the user can also refer to requests from another data processing system. In such a case, the above advantages can optionally apply analogously.

The system can further be configured for storing the pre-calculated data.

The data-storage component can further be configured for storing the pre-calculated data.

The system is configured to transmit the pre-calculated data to the second data-processing system.

The output-determining component can be configured to determine at least a portion of the condition-states and/or condition-nodes based on the pre-calculated data.

That can be, the output-determining component can be configured to determine at least a portion of the condition-states and/or condition-nodes corresponding to the specified condition-states and/or condition-nodes based on data generated by the pre-calculating component.

The second data-processing system can be configured to determine at least a portion of the condition-states and/or condition-nodes based on the pre-calculated data.

This can be advantageous when the second data-processing system comprises end-user computer devices. In such a case, the second data-processing system may comprise a lower computing power than the first data processing system and might not only take longer for generating responses to requests from users or another data-processing system, but the second data-processing system might not be suitable to generate responses at all within an acceptable response time. Hence, in such a configuration, there may be a particular advantage regarding a response time of the system, particularly of the second data-processing system.

The system can be configured to output the condition-node values and/or the condition-state values corresponding to the condition-nodes and/or condition-states to be outputted based on the pre-calculated data.

The second data-processing system can be configured to output the condition-node values and/or the condition-state values corresponding to the condition-nodes and/or condition-states to be outputted based on the pre-calculated data.

The pre-calculated data calculated data can be pre-calculated by the pre-calculating component as discussed above.

The data to be outputted can be determined by the system and/or by the output-determining component as discussed above.

The data-storage component can be configured to store the pre-calculated data.

The data-storage component can be configured to store the pre-calculated data in a graph-database.

The data-storage component can be configured to store the pre-calculated data in a document-oriented database.

The data-storage component can be configured to store the pre-calculated data in source code of an application for operating the system. An advantage can be that a time that the system takes to generate responses may be shortened by a factor of 10 up to 1000 in comparison to storage in a database.

The at least one second data processing system can be a plurality of second data processing systems.

The data-storage component can be configured for storing at least indicator of one subset of the condition-nodes and of one of the condition-states for each of the second data processing systems.

The system can further be configured to store and process for each second data-processing system a set of condition-node values.

The system can further be configured to store and process for each second data-processing system a set of condition-state values.

The system can further be configured to store and process for each second data-processing system a set of comparison results.

The system can further be configured to store and process for each second data-processing system a set of condition-state thresholds.

In other words, the system can be configured to store at least an indicator for a subset of condition-nodes and/or condition-states for each of second data-processing system. Each second data-processing system can be configured to model or represent a system to be modelled or represented.

In such a case, obviously, one physical device like a smart phone or another end user computer device can comprise at least a portion of two second data-processing systems. This can for example be the case when the one physical device stores or displays data relating to two systems, e.g. in a case where a ship owner keeps track of the state on his ships or when a foreman in a production plant keeps track of all production lines under his supervision.

The system can also store a subset of condition-nodes and/or a subset of condition-states for each second data-processing system.

The subsets which are stored or whose indicators are stored for each second data-processing system can be the same for different second-data processing systems, some can be different, but they can also all be different.

For every second data-processing system, the system can store and process a set of condition-node values. Each set can comprise condition-node values for each condition-node of the subset of condition-nodes corresponding to the respective second-data processing system.

For every second data-processing system, the system can store and process a set of condition-state values, comparison results and/or condition-state thresholds. Each set can comprise data for each condition-state of the subset of condition-states corresponding to the respective second-data processing system.

An advantage of storing and processing sets of values for each second data-processing system can be that the system can be configured to store and process data relating to multiple systems to represent or model that are independent from each other.

The system can be a risk-management system.

The system can be a system for risk assessment.

The system can be a system for risk assessment of a system.

The system can be a system for risk assessment of an IT-system.

The system can be a system for risk assessment of a financial service provider.

The system can be a system for risk assessment of a data processing facility.

The system can be a system for risk assessment of a production system.

The system can be a system for risk assessment of an organisation.

The system can be a system for risk assessment of a vessel.

The system can be a system for risk assessment of an aircraft.

The above-mentioned objectives can also be met by a method as described in the following.

In one embodiment, the method comprises using at least one of the first data-processing system and the second data-processing system to perform the method. The method further comprises storing a plurality of the condition-nodes and at least one condition-state, wherein each condition-state is assigned to at least one condition-node. The method further comprises storing at least one node-link(s). Each of the node-link(s) connects two condition-nodes. The method further comprises a condition-state determining step (CSD). The CSD comprises for each condition-state of at least a subset of the condition-states generating a value and assigning this generated value to the respective condition-state.

The method can further comprise a condition-state processing step (CSP). The condition-state processing step can comprise for each condition-node of at least the subset of the condition nodes aggregating the values assigned to the condition-states relating to the respective condition-node. The condition-state processing step can thus comprise generating a condition-node modifier for each condition-node.

Each of the node-links can be directed. That is, a graph resulting from an interpretation of the node-links as edges and the condition-nodes as vertices can be directed.

Said resulting graph can further be non-cyclic.

Each condition-state can comprise a condition-state threshold and a condition-state value. The condition-state, the condition-state threshold and/or the condition-state value can comprise the above-discussed features.

In the condition-state determining step (CSD), for each condition-state of at least the subset of the condition-states, the generating of the value can comprise comparing the respective condition-state threshold and the condition-state value and thus generating a respective comparison result. In other words, the condition-state determining step can comprise generating a comparison result for all condition-states or at least the condition-states of at least the subset of the condition-states by comparing each condition-state's condition-state threshold and the respective condition-state value.

The condition-state determining step can further comprise assigning each comparison result to the respective condition-state. Hence, each condition-state for which a value was generated can after the condition-state determining step comprise a comparison result.

It is to be noted that the term “condition-state value” is intended to refer to a value that can be received in the method. It can for example be received from at least one of user input, a data-processing system and at least one sensing device. The condition-state determining step may not comprise generating said condition-state value. However, the condition-state determining step may comprise generating a value for each of at least one or a plurality of condition-states as discussed above. Said values to be generated can be the comparison results. They can each relate to one condition-state.

That is, the value generated for each condition-state or each condition-state of a plurality of condition-states in the condition-state determining step can be the comparison result.

Comparing can comprise neglecting a certain range of values, e.g. assigning all negative results 0 as value, normalizing comparison results or the like.

Aggregating the values assigned to the condition-states which aggregating can be performed in the condition-state processing step can comprise aggregating the comparison result of the respective condition-states.

That is, the condition-state processing step can comprise for each condition-node of at least the subset if the condition-nodes aggregating the comparison results of the condition-states that are assigned to the respective condition-node. Hence, a condition-node modifier can be generated for each of the condition-nodes. The condition-node modifier may be the value by which the respective condition-node is impacted due to the condition-states that are assigned thereto.

In another embodiment, the method comprises using at least one of the first data-processing system and the second data-processing system to perform the method. The method further comprises storing the plurality of the condition-nodes and the at least one condition-state, wherein each condition-state is assigned to at least one condition-node. Each condition-state comprises a condition-state threshold and a condition-state value. The method further comprises storing the at least one node-link(s), wherein each node-link connects two condition-nodes and each node-link is directed. The method further comprises the condition-state determining step (CSD). The condition-state determining step (CSD) comprises for each condition-state of at least a subset of the condition-states comparing the respective condition-state value and the respective condition-state threshold and thus generating a respective comparison result, and assigning the comparison result to the respective condition-state. The method further comprises a condition-state processing step (CSP), which comprises for each condition-node of the subset of the condition nodes aggregating the comparison results of the condition-states of the subset of the condition-states relating to the respective condition-node and thus generating a condition-node modifier for the respective condition-node.

It is to be understood that the following features can relate to each of the method embodiments discussed in the foregoing.

Comparing the respective condition-state value and the respective condition-state threshold and thus generating a respective comparison result can comprise calculating a distance of the respective condition-state value and the respective condition-state threshold.

That is, a comparison result for a condition-state can be generated by calculating a distance of the condition-state's condition-state value and the condition-state's condition-state threshold.

Calculating a distance is intended to refer to calculating a measure for a distance, e.g. in the simplest case a difference of two scalar values. Such a measure can also be an absolute value of said difference of the two scalar values. The measure for the distance can also be a measure of a distance of two vector values, such as an absolute value of their difference based on the Euclidean distance, the Chebyshev distance or another distance measure.

Comparing the respective condition-state value and the respective condition-state threshold and thus generating a respective comparison result can comprise limiting the respective comparison result to a certain range of values.

Limiting the respective comparison result can comprise treating values above or below a certain threshold differently, e.g. limiting the result to 0 as a maximum or minimum.

The method can further comprise a condition-node processing step (CNP). The condition-node processing step (CNP) can comprise for each condition-node of the subset of the condition-nodes generating a condition-node value and assigning this condition-node value to the respective condition-node.

The step of generating the condition-node value for each condition-node of the subset of the condition-nodes can comprise combining the condition-node modifier of the respective condition-node, and the condition-node value of each condition-node of at least the subset of the condition-nodes that is linked to the respective condition-node by a node-link that is directed towards the respective condition-node.

Combining the condition-node modifier and the condition-node value of a condition-state can for example refer to summing these values up, calculating a weighted sum or evaluating a function that takes these values as parameter.

The condition-nodes that are linked to the respective condition-node by a node-link that is directed towards the respective condition-node can for example be identified by checking all node-links for whether they lead said respective condition-node.

The step of generating the condition-node value in the condition-node processing step (CNP) can also comprise combining the condition-node modifier of the respective condition-node, and the condition-node value of each condition-node of the subset of the condition-nodes that is linked to the respective condition node by a node-link that is directed towards the respective condition node, wherein each respective condition-node value is combined with a node-link value associated with the respective node-link.

That is, each condition-node value that is combined for a condition-node in the condition-node processing step with the condition-node modifier the respective condition-node and other condition-node values (if there are other condition-nodes linked to the respective condition-node) can be combined with the node-link value of the node-link.

Said combining can for example be a multiplying. In other words: An impact of condition-node values of condition-nodes on other condition-node values can be weighted by the node-link values of the node-links linking the condition-nodes. An advantage is that an impact of condition-nodes or risks that they represent and/or model can be weighted in the model and/or representation.

The step of generating the condition-node value for each condition-node of the subset of the condition-nodes can comprise combining the condition-node modifier of the respective condition-node, and the condition-node value of each condition-node of the subset of the condition-nodes that is linked to the respective condition node by a node-link from a subset of the node-links and which node-link is directed towards the respective condition node.

That is, the method can also be limited to applying only a subset of the node-links.

The step of generating the condition-node value in the condition-node processing step (CNP) can also comprise combining the condition-node modifier of the respective condition-node, and the condition-node value of each condition-node of the subset of the condition-nodes that is linked to the respective condition node by a node-link from the subset of the node-links and which node-link is directed towards the respective condition node, wherein each respective condition-node value can be combined with a node-link value associated with the respective node-link.

The condition-node processing step (CNP) can be performed by the first data-processing system.

However, the condition-node processing step (CNP) can also be performed by the second data-processing system.

The method further can further comprise a condition-state selecting step (CSS). The condition-state selecting step (CSS) can comprise receiving input data that indicate at least a part or all of the condition-states of the subset of the condition-states.

The data that indicate at least a part or all of the condition-states can comprise data relating to the condition-state(s). They can also comprise data that are only an indicator of the condition-state(s), such as its/their name(s), reference number(s), code(s) for or reference(s) to the condition-state(s).

The data that indicate at least a part or all of the condition-states can also comprise an indicator of at least one or a plurality of groups of condition-states, such as a reference or an indicator of a technical sub-system for which a plurality of condition-states are applicable, such as condition-states applicable for a ship with a diesel-electric power-train, or condition-states applicable based on a regulation, for example environmental rules requiring a manufacturing plant to control its emissions.

The condition-state selecting step (CSS) can further comprise storing the subset of the condition-states according to the received input data that indicate at least the part or all of the condition-states.

The received input data that indicate at least the part or all of the condition-states can comprise data that indicate at least one or a plurality of groups of condition-states.

In line with the remark above, the data indicate at least one or a plurality of groups of condition-states can comprise data relating to the groups of condition-states. They can also comprise data that are only an indicator of such group(s), such as their name(s), reference number(s), a code or a plurality of codes referring thereto or reference(s) to said group(s).

The condition-state selecting step (CSS) can comprise merging the at least one or the plurality of groups of condition-states to obtain the subset of the condition-states. Merging the at least one or the plurality of groups of condition-states can mean generating the union of the groups of the condition-states, wherein the term “union” is to be understood in the sense of set theory.

The step of receiving the input data that indicate at least a part or all of the condition-states of the subset of the condition-states can be performed by the second data-processing system.

The method can further comprise a condition-node selecting step (CNS). The condition-node selecting step can comprise receiving input data that indicate at least a part or all of the condition-nodes of the subset of the condition-nodes.

The condition-node selecting step (CNS) can further comprise storing the subset of the condition-nodes according to the received input data that indicate at least the part or all of the condition-nodes.

The data that indicate at least a part or all of the condition-nodes can comprise data relating to the condition-node(s). They can also comprise data that are only an indicator of the condition-node(s), such as their name(s), reference number(s), code(s) for or reference(s) to the condition-state.

The input data that indicate at least the part or all of the condition-nodes of the subset of the condition-nodes can comprise data that indicate at least one or a plurality of groups of condition-nodes.

The data that indicate at least a part or all of the condition-nodes can also comprise an indicator of at least one or a plurality of groups of condition-nodes, such as a reference or an indicator of a technical sub-system for which a plurality of condition-nodes are applicable, such as condition-nodes applicable for a vehicle with a diesel-combustion engine.

The condition-node selecting step (CNS) can further comprise merging the at least one or the plurality of groups of condition-nodes to obtain the subset of the condition-nodes.

Merging the at least one or the plurality of groups of condition-nodes can mean generating the union of the groups of the condition-nodes, wherein the term “union” is to be understood in the sense of set theory.

Receiving the input data that indicate at least a part or all of the condition-nodes of the subset of the condition-states can be performed by the second data-processing system.

The input data that indicate at least a part or all of the condition-nodes of the subset of the condition nodes can comprise the input data that indicate at least a part or all of the condition-states of the subset of the condition-states.

The condition-node selecting step (CNS) can also comprise selecting condition-nodes based on the input data that indicate at least a part or all of the condition-states of the subset of the condition-states.

In other words, the condition-node selecting step can comprise selecting condition-nodes based on applicable condition-states.

This can for example be done by selection all condition-nodes to which selected condition-states are assigned.

It is to be noted that the condition-states can comprise their assignments, that is, that with the selection of a condition-states, it can be clear to which condition-nodes said condition-state is assigned.

The method can further comprise a node-link selecting step (NLS). The node-link selecting step can comprise receiving input data that indicate at least a part or all of the node-links of the subset of the node-links.

The data that indicate at least a part or all of the node-links can comprise data relating to the node-link(s). They can also comprise data that are only an indicator of the node-link(s), such as their name(s), reference number(s), code(s) for or reference(s) to the node-link(s).

The node-link selecting step (NLS) can comprise furthermore storing the subset of the nodes according to the received input data that indicate at least the part or all of the node-links.

The input data that indicate at least the part or all of the node-links of the subset of the node-links can comprise data that indicate at least one or a plurality of groups of node-links.

The data that indicate at least a part or all of the node-link(s) can also comprise an indicator of at least one or a plurality of groups of node-link(s).

The node-link selecting step can comprise merging the at least one or the plurality of groups of node-links to obtain the subset of the node-links.

Merging the at least one or the plurality of groups of node-link(s) can mean generating the union of the groups of the node-link(s), wherein the term “union” is to be understood in the sense of set theory.

The step of receiving the input data that indicate at least a part or all of the node-links of the subset of the node-links can be performed by the second data-processing system.

The method can further comprise a condition-state value receiving step (CSV). The condition-state value receiving step (CSV) can comprise receiving input data that indicate at least a part of the condition-state values.

Receiving input data that indicate at least a part of the condition-state values can comprise receiving input data from a data-processing system.

Receiving input data that indicate at least a part of the condition-state values can also comprise receiving input data from at least one or a plurality of sensing devices.

Receiving input data that indicate at least a part of the condition-state values can also comprise receiving input data from the user interface.

The method can further comprise an outputting step (OS). The outputting step can comprise outputting data.

The outputting step can comprise outputting condition-node values of the condition-nodes of the subset of the condition-nodes.

The outputting step can comprise outputting node-links linking the condition-nodes of the subset of the condition nodes.

The outputting step can comprise outputting comparison results of the condition-states of the subset of the condition states.

The outputting step can comprise outputting at least a part or all of the respective data to a user interface. That is, the data to be outputted can be outputted to the user interface.

Said outputting to the user interface can be performed by the second data-processing system.

The outputting step can comprise storing at least a part or all of the respective data, that is the data to be outputted, by the second data-processing system.

The outputting step can also comprise processing at least a part or all of the respective data, that is the data to be outputted, by the second data-processing system.

That is, the data to be outputted can be stored and/or stored by the second-data processing system. This can be advantageous to limit an amount of data to be communicated from the first to the second data-processing system. This can further be advantageous to reduce a response time of the second data-processing system.

The outputting step can comprise transmitting at least a part or all of the respective data, that is the data to be outputted, to a third data-processing system.

Said transmitting to the third data-processing system can be performed at least partially by the first data-processing system.

The third data-processing system can be any other data-processing system that the system does not comprise.

The outputting step can comprise outputting at least one of condition-nodes and condition-states that are linked by one or more node-links to at least one of a specified condition-node and a specified condition-state.

The term “linked” is intended to refer to any kind of link. That is, it can refer to node-links, regardless of their orientation/direction, but it can also refer to assignments of condition-states to condition-nodes. However, in cases where condition-state A is assigned to condition-node B and condition-node C, B and C are not considered to be linked by the assignment via A, but only A and B as well as A and C. However, B and C can still be linked via node-links.

The outputting step can comprise outputting data that comprise at least one of condition-nodes and condition-states to be outputted that are each linked to at least one of a specified condition-node and a specified condition-state according to a linking-criterion.

The specified condition-node can be a condition-node specified by the user and/or by the third data-processing system. The method can also comprise performing the outputting step once for each specified condition-node of a plurality of condition-nodes or outputting data for each specified condition-node of the plurality of condition-nodes in the outputting step.

The specified condition-state can be a condition-state specified by the user and/or by the third data-processing system. The method can also comprise performing the outputting step once for each specified condition-state of a plurality of condition-states or outputting data for each specified condition-state of the plurality of condition-states in the outputting step.

The linking criterion can be a criterion that specifies which condition-nodes and/or condition-states are to be outputted based on input data, wherein the input data can be at least one of
the specified condition-states,
the specified condition-nodes, and
the specified condition-states together with the specified condition-nodes.

The linking-criterion can be a linking criterion for outputting condition-nodes based on a specified condition-node. The linking-criterion can comprise that there is a set of node-links connecting each condition-node to be outputted to the specified condition-node in the sense of the node-links. That is, the linking criterion can comprise that from each condition-node to be outputted, the specified condition-node is reachable.

It is to be noted that the term “reachable” is intended to refer to an interpretation of the condition-nodes and condition-links as nodes and vertices of a directed, acyclic graph. Hence, condition-states that are assigned to condition-nodes do not impact whether a condition-node A is reachable from another condition-node B.

That is, the outputting step can comprise outputting all condition-nodes whose condition-node values can impact the specified condition-node.

The linking-criterion can be a linking criterion for outputting condition-states based on a specified condition-node. The linking-criterion can comprise that each condition state to be outputted can be assigned to the specified condition-node.

A condition-state can be assigned to one or more condition-nodes.

That is, the outputting step can comprise outputting all condition-states that are assigned to a specified condition-node.

The linking-criterion can be a linking criterion for outputting condition-states based on a specified condition-node. The linking-criterion can comprise that each condition-state to be outputted is connected to the specified condition-node at least indirectly. That is, the condition-states to be outputted can either be assigned to the specified condition-node or to a condition-node from which the specified condition-node is reachable.

That is, the outputting step can comprise outputting all condition-states that are assigned to the specified condition-node or to a condition-node from which the specified condition-node is reachable.

In other words, the outputting step can comprise outputting all condition-states whose comparison results can impact the specified condition-node.

The linking-criterion can be a linking criterion for outputting condition-nodes based on a specified condition-node. The linking-criterion can comprise that there is a set of node-links connecting the specified condition-node to each condition-node to be outputted in the sense of the node-links. In other words, the linking criterion can comprise that the condition-nodes to be outputted are reachable from the specified condition-node.

That is, the outputting step can comprise outputting the condition-nodes that are reachable from the specified condition-node.

The linking-criterion can also be a linking criterion for outputting condition-nodes based on a specified condition-state. The linking-criterion can comprise that the specified condition state is assigned to each condition-node to be outputted.

In other words, the outputting step can comprise outputting the condition-nodes to which the specified condition-state is assigned.

The linking-criterion can be a linking criterion for outputting condition-nodes based on a specified condition-state. The linking-criterion can comprise that each condition-node to be outputted is connected to the specified condition-state at least indirectly. That is, the linking-criterion can comprise that the condition-nodes to be outputted comprise the condition-nodes to which the specified condition-state is assigned and the condition-nodes that are reachable from the condition-nodes to which the specified condition-state is assigned.

In other words, the outputting step can comprise outputting the condition-nodes that can change when the specified condition-state or a value belonging thereto, such as the specified condition-state's comparison result, changes.

The method can comprise performing the outputting step for a plurality of different linking criteria. The method can also comprise performing the outputting step for a plurality of different specified condition-states and/or condition-nodes.

In other words, the outputting step can be performed for different input data. The input data can differ at least regarding the linking criterion. They can also differ regarding a specified element, that is the specified condition-state and/or the specified condition-node. The person skilled in the art will easily understand that thus, also combinations of linking criteria and specified condition-state/specified condition-node can differ.

The outputting step can comprise outputting at least one or a plurality of condition-node values of the condition-nodes to be outputted.

The outputting step can also comprise outputting at least one or a plurality of condition-state values of the condition-states to be outputted.

The outputting step can comprise outputting only condition-states that belong to one subset of condition-states. The outputting step can also comprise for each combination of a linking criterion and a specified condition-state and/or a specified condition-node outputting only condition-states that belong to one subset of condition-states. However, the subsets can be different between the combinations or some of the combinations.

The outputting step can comprise outputting only condition-nodes that belong to one subset of condition-nodes. The outputting step can also comprise for each combination of a linking criterion and a specified condition-state and/or a specified condition-node outputting only condition-nodes that belong to one subset of condition-nodes. However, the subsets can be different between the combinations or some of the combinations.

The method can further comprise a pre-calculating step (PCS). The pre-calculating step can comprise determining at least one of the condition-nodes and the condition-states to be outputted for at least one or a plurality of linking-criteria and a plurality of the at least one of the specified condition-node and the specified condition-state and to thus generate pre-calculated data.

That is, the pre-calculating step can comprise pre-calculating the condition-nodes and/or the condition-states to be outputted for different input data, wherein the input data comprise at least one or multiple linking criteria and a plurality of specified condition-nodes and/or condition-states.

An advantage of this method step can be that the method provides data to the user or the third data-processing system with a lower response time. This can be due to the fact that determining the condition-nodes and/or condition-states to be outputted based on a linking criterion and a specified condition-node or specified condition-state respectively can be an NP-hard problem. Thus, determining these condition-nodes and/or condition-states to be outputted only upon request may lead to a considerable response time. However, pre-calculating these condition-nodes and/or condition-states to be outputted may shorten the response time since looking up a result can be performed with a significantly lower (computational) time complexity. Hence, the pre-calculating step may be still more advantageous when the number of condition-nodes and the number of condition-links are high, as in such a case, a lookup of a pre-calculated result or at least a pre-calculated part of the result can be significantly faster or significantly less demanding in computing power than calculating the result.

The pre-calculating step (PCS) can further comprise storing said pre-calculated data.

The pre-calculating step (PCS) can be performed by the first data-processing system.

This can be advantageous in particular in cases where the first data-processing system is a server, cloud-computer system or the like as discussed above. In such cases, the first-data processing system may comprise a higher computing power then the second data-processing system. Also, in case where the second data-processing system comprises mobile devices, an advantage of using the first data-processing system for the pre-calculating can be a simpler access to power, in particular when the first data-processing system is stationary.

The pre-calculated data can be stored at least at the second data-processing system.

The outputting data can be based on the pre-calculated data.

The outputting step can be performed based on the pre-calculated data.

The method can comprise determining the at least one of the plurality of the condition-node values and the condition-state values based at least on the pre-calculated data.

In other words, the method can comprise determining the at least one of the condition-nodes to be outputted and the condition-states to be outputted based at least on the pre-calculated data.

However, the determining can still comprise further steps, input data or parameters. That is, the data to be outputted do not need to be exclusively determined based on the pre-determined data.

The method can comprise determining the at least one of the plurality of the condition-node values and the condition-state values by the second data-processing system.

Storing the at least one node-link(s) and storing the plurality of the condition-nodes can comprise storing the at least one node-link(s) and storing the plurality of the condition-nodes

in a graph database. Storing the at least one condition state can comprises storing the at least one condition-state

in a document-oriented database.

The method can comprise storing the pre-calculated data in a graph database. An example for a graph database can be the Neo4j graph database.

The method can comprises storing the pre-calculated data in a document-oriented database.

The method can further comprise storing the pre-calculated data in source code of an application for carrying out the method and furthermore compiling said source code.

In other words, the method can comprise pre-calculating all possible permutations of the node-links and storing them in the source code of the application. Hence, at runtime, a pre-calculated result can be selected from the pre-calculated data and be used for further calculation.

This can be particularly advantageous as retrieving information that is stored in data of the application can be significantly faster than retrieving data from a database. Hence, this embodiment may further reduce the response time to requests. In experiments, the lookup time was reduced by around a factor 1000 compared to data-base calls.

The method can further comprise the first data-processing system and a plurality of second data-processing systems. The plurality of the second data-processing systems can be according to the remarks above.

The method can further comprise performing the condition-state determining step for each second data-processing system.

Each subset of the condition-states can correspond to at least one or exactly one second data-processing system. The subsets can for example be the same in a case where identical systems or organisations are modelled. The subsets can for example be different in a case where systems with different risks or applicable measures are modelled.

The method can also comprise performing the condition-state processing step (CSP) for each second data-processing system, wherein each subset of the condition-nodes corresponds to at least one second data-processing system.

The method can further comprise storing separate sets of values for the condition-node values, the condition-node modifiers, the condition-state values and the comparison results for each second data-processing system. That is, the system process input data separately for different second data-processing systems. This can be advantageous for example in a case where a ship owner owns a fleet of 20 ships for which one central server keeps the data. In such a case, even if all 20 ships are from a same type and age, values representing their conditions and/or measures taken by the crew can be different for each ship. In such a case, the method allows using only one first data-processing system for modelling states of all 20 ships.

The method may further comprise storing separate sets of values for the condition-node thresholds for each of the second data-processing systems. This can be advantageous when the modelled systems operate under different circumstances or when they are different.

The method can comprise performing the condition-node processing step (CNP) for each set of the sets of values.

Each set of values can comprise set of values relating to at least one second data-processing system, comprising at least the condition-node values generated in the condition-node processing step.

The method can comprise performing the condition-state selecting step for each set of the sets of values.

Each set of values can comprise a subset of condition-states selected in the respective condition-state selecting step. Each set of values can relate to at least one second-data processing-system.

However, the subsets of the condition-states selected in respective condition-state selecting steps can also be the same for a plurality of second data-processing systems.

The method can further comprise performing the condition-node selecting step (CNS) for each set of the sets of values.

Each set of values can comprise a subset of condition-nodes selected in the respective condition-node selecting step. Each set of values can relate to at least one second-data processing-system.

However, the subsets of the condition-nodes selected in respective condition-node selecting steps can also be the same for a plurality of second data-processing systems.

The method can also comprise performing the condition-state value receiving step (CSV) for each set of the sets of values.

Each set of values can comprise set of values relating to at least one second data-processing system, comprising at least the input data received in the condition-state value receiving step.

The method can also comprise furthermore performing the outputting step (OS) for each set of the sets of values.

The method can be a method for risk assessment.

The method can be a method for risk assessment of a system.

The method can be a method for risk assessment of an IT-system.

The method can be a method for risk assessment of a financial service provider.

The method can be a method for risk assessment of a data processing facility.

The method can be a method for risk assessment of a production system.

The method can be method for risk assessment of an institution.

The method can be a method for risk assessment of a vessel or an aircraft.

The invention is further directed to a computer program comprising instructions causing the system to execute steps of the method.

The invention is also directed to a computer program comprising instructions causing the first data-processing system to execute steps of the method that are to be executed by the first data-processing system.

The invention is furthermore directed to a computer program comprising instructions causing at least one of the at least one second data-processing system to execute steps of the method according to that are to be executed by the second data-processing system.

The following numbered embodiments also form part of the invention.

Below, system embodiments will be discussed. These embodiments are abbreviated by the letter “S” followed by a number. Whenever reference is herein made to “system embodiments”, these embodiments are meant.
S1 A system, comprising a first data-processing system (10) and at least one second data-processing system (14, 15).
S2 The system according to the preceding system embodiment, wherein the system is configured for at least one of
   processing data,
   storing data,
   receiving input data and
   transmitting data.
S3 The system according to any of the preceding system embodiments, wherein the system comprises
   a processing component, and a
   a data-storage component.
S4 The system according to any of the preceding system embodiments, wherein the at least one second data-processing system (14, 15) is configured for transmitting data to the first data-processing system (10).
S5 The system according to any of the preceding system embodiments with the features of S4, wherein the second data-processing system (14, 15) is further configured to receive input data from at least one of a document sensing unit, a data storage device and/or user input.
S6 The system according to any of the preceding system embodiments with the features of S4,
   wherein the second data-processing system (14, 15) is configured to receive data from the first data-processing system (10), and
   wherein the second data-processing system (14, 15) comprises a user interface configured to output said data to at least one user.
S7 The system according to any of the preceding system embodiments with the features of S4, wherein the second data-processing system (14, 15) comprises at least a portion of at least one or a plurality of at least one end-user computer device.
S8 The system according to the preceding system embodiment, wherein the at least one end-user computer device is the plurality of end-user computer devices.
S9 The system according to any of the preceding system embodiments with the features of S4, wherein the first data-processing system (10) is configured for transmitting data to at least a portion of the second data-processing system (14, 15).
S10 The system according to any of the preceding system embodiments with the features of S4, wherein the first data-processing system (10) is configured for receiving data from at least a portion of the second data-processing system (14, 15).
S11 The system according to any of the preceding system embodiments, wherein the first data-processing system (10) is configured for transmitting data to a third data-processing system (14, 15).
S12 The system according to any of the preceding system embodiments with the features of S4, wherein
   the system comprises a plurality of second data-processing systems (14, 15),
   each of the second data-processing systems (14, 15) is according to embodiment S4 or to any of the embodiments depending on S4, and
   the first data-processing system (10) is configured to transmit data to and/or receive data from each of the second data-processing systems (14, 15).
S13 The system according to any of the preceding system embodiments with the features of S11, wherein the first data-processing system is configured for transmitting data to a plurality of third data processing systems (14, 15).
S14 The system according to any of the preceding system embodiments with the features of S3, wherein the processing component (60) comprises a condition-state determining component (62).
S15 The system according to any of the preceding system embodiments with the features of S3, wherein the processing component (60) comprises a condition-state processing component (64).
S16 The system according to any of the preceding system embodiments with the features of S3, wherein the processing component (60) comprises a condition-node processing component (66).
S17 The system according to any of the preceding system embodiments with the features of S3, wherein the processing component (60) comprises an input-processing component (68).
S18 The system according to any of the preceding system embodiments with the features of S3, wherein the processing component (60) comprises an output-determining component (70).
S19 The system according to any of the preceding system embodiments, wherein the system comprises at least one user interface (82).
S20 The system according to any of the preceding system embodiments, wherein the second data-processing system (14, 15) comprises the at least one user interface (82).
S21 The system according to any of the preceding system embodiments with the features of S3, wherein the processing component (60) comprises a pre-calculating component (74).
S22 The system according to any of the preceding system embodiments with the features of S14 and S18, wherein the output-determining component (70) comprises the condition-state determining component (62).
S23 The system according to any of the preceding system embodiments with the features of S15 and S18, wherein the output-determining component (70) comprises the condition-state processing component (64).
S24 The system according to any of the preceding system embodiments with the features of S16 and S18, wherein the output-determining component (70) comprises the condition-node processing component (66).
S25 The system according to any of the preceding system embodiments with the features of S17 and S18, wherein the output-determining component (70) comprises the input-processing component (68).
S26 The system according to any of the preceding system embodiments with the features of S3,
   wherein the data-storage component (80) is configured for storing a plurality of condition-nodes (20).
S27 The system according to any of the preceding system embodiments with the features of S26,
   wherein the data-storage component (80) is further configured for storing a plurality of condition-node modifiers (22) and wherein each condition-node modifier (22) relates to a condition-node (20).
S28 The system according to any of the preceding system embodiments with the features of S26,
   wherein the data-storage component (80) is further configured for storing a plurality of condition-node values (24) and wherein each condition-node (20) comprises a condition-node value (24).
S29 The system according to any of the preceding system embodiments with the features of S3,
   wherein the data-storage component (80) is configured for storing at least one or a plurality of condition-states (30).
S30 The system according to any of the preceding system embodiments with the features of S26 and S29, wherein the data-storage component (80) is further configured for storing a plurality of assignments, wherein each assignment assigns a condition-state (30) to at least one of the condition-nodes (20).
S31 The system according to any of the preceding system embodiments with the features of S29, wherein the data-storage component (80) is further configured for storing a plurality of condition-state thresholds (34) and wherein each condition-state comprises a condition-state threshold (34).
S32 The system according to any of the preceding system embodiments with the features of S29, wherein the data-storage component (80) is further configured for storing a plurality of condition-state values (36) and wherein each condition-state (30) comprises a condition-state value (36).
S33 The system according to any of the preceding system embodiments with the features of S29, wherein the data-storage component (80) is further configured for storing a plurality of comparison results (38) and wherein each condition-state (30) comprises a comparison result (38).
S34 The system according to any of the preceding system embodiments with the features of S26, wherein the data-storage component (80) is further configured for storing at least one or a plurality of node-links (40).
S35 The system according to the preceding system embodiment, wherein the data-storage component (80) is further configured for storing a node-link value (42) for each node-link (40) and wherein each node-link further comprises a node-link value (42).
S36 The system according to any of the two preceding system embodiments, wherein the node-links (40) are directed.

S37 The system according to any of the preceding system embodiments with the features of S26, wherein the data-storage component (80) is configured for storing at least one or a plurality of subset(s) of the condition-nodes (50, 51).
S38 The system according to any of the preceding system embodiments with the features of S29, wherein the at least one or the plurality of condition-states (30) is a plurality of condition states (30) and wherein the data-storage component (80) is configured for storing at least one or a plurality of subset(s) of the condition-state (52, 53).
S39 The system according to any of the preceding system embodiments with the features of S34, wherein the at least one or the plurality of node-links is a plurality of node-links and wherein the data-storage component (80) is configured for storing at least one or a plurality of subset(s) of the node-links (54, 55).
S40 The system according to any of the preceding system embodiments with the features of S14, wherein the system is configured to perform for each condition-state (30) of at least a subset of the condition states (52, 53)
   (a) comparing each condition-state value (36) and the respective condition-state threshold (34),
   (b) thus generating a comparison result (38) for each of these condition-states (30), and
   (c) further assigning each comparison result (38) to the respective condition-state (30).
S41 The system according to any of the preceding system embodiments with the features of S14, wherein the condition-state determining component (62) is configured to perform for each condition-state (30) of at least a subset of the condition states (52, 53)
   (a) comparing each condition-state value (36) and the respective condition-state threshold (34),
   (b) thus generating a comparison result (38) for each of these condition-states (30)
   (c) further assigning the comparison result (38) to the respective condition-state (30).
S42 The system according to any of the preceding system embodiments, wherein the system is configured for generating a condition-node modifier (22) for each condition-node (20) of at least a subset of condition-nodes (50, 51) by aggregating the comparison results (38) of the condition-states (30) of at least a subset of the condition-states (52, 53) which condition-states (30) are assigned to the respective condition-node (20).
S43 The system according to any of the preceding system embodiments with the features of S15, wherein the condition-state processing component (64) is configured for generating a condition-node modifier (22) for each condition-node (20) of at least a subset of condition-nodes (50, 51) by aggregating the comparison results (38) of the condition-states (30) of at least a subset of the condition-states (52, 53) which condition-states (30) are assigned to the respective condition-node (20).
S44 The system according to any of the preceding system embodiments with the features of S40 and/or S41, wherein the system is configured to compare the condition-state values (36) and condition-state thresholds (34) of at least the subset of the condition-states (52, 53) by calculating a distance of the each condition-state value (36) and the respective condition-state threshold (34) and to generate the respective comparison result (38) based on this distance.
S45 The system according to any of the preceding system embodiments with the features of S40 and/or S41, wherein the condition-state determining component (62) is configured to compare the condition-state values (36) and condition-state thresholds (34) of at least the subset of the condition-states (52, 53) by calculating a distance of the each condition-state value (36) and the respective condition-state threshold (34) and to generate the respective comparison result (38) based on this distance.
S46 The system according to any of the preceding system embodiments with the features of S40 and/or S41, wherein the condition-state determining component (62) comprises a limiting element (72) that is configured to limit the comparison results (38) to a certain range of values.
S47 The system according to any of the preceding system embodiments with the features of S40 and/or S41, wherein the system comprises a limiting element (72) that is configured to limit the comparison results (38) to a certain range of values.
S48 The system according to any of the preceding system embodiments with the features of S16, wherein the system and/or the condition-node processing component (66) is configured for generating a condition-node value (24) for each condition-node (20) of at least the subset of condition-nodes (50, 51).
S49 The system according to the preceding system embodiment, wherein the system and/or the condition-node processing component (66) is further configured for assigning each condition-node value (24) to the respective condition-node (20).
S50 The system according to any of the preceding system embodiments with the features of S48 and at least one of S42 and S43, wherein the condition-node processing component (66) is further configured for combining for each condition-node (20) of at least the subset of the condition-nodes (50, 51):
   (a) the condition-node modifier (22) of the respective condition-node (20) and
   (b) the condition-node values (24) of all condition-nodes (20) of the subset of condition-nodes (50, 51) which are respectively linked to the respective condition-node (20) by a node-link (40) that is directed towards the respective condition-node (20).
S51 The system according to any of the preceding system embodiments with the features of S48 and at least one of S42 and S43, wherein the system is further configured for combining for each condition-node (20) of at least the subset of the condition-nodes (50, 51):
   (a) the condition-node modifier (22) of the respective condition-node (20) and
   (b) the condition-node values (24) of all condition-nodes (20) of the subset of condition-nodes (50, 51) which are respectively linked to the respective condition-node (20) by a node-link (40) that is directed towards the respective condition-node (20).
S52 The system according to any of the preceding system embodiments with the features of S48 and at least one of S42 and S43, wherein the condition-node processing component (66) is further configured for combining for each condition-node (20) of at least the subset of the condition-nodes (50, 51):
   (a) the condition-node modifier (22) of the respective condition-node (20),
   (b) the condition-node values (24) of all condition-nodes (20) of the subset of condition-nodes (50, 51) which are respectively linked to the respective condition-node (20) by a node-link (40) that is directed towards the respective condition-node (20), and
   (c) the node-link values (42) of the node-links (20) connecting said condition-nodes.
S53 The system according to any of the preceding system embodiments with the features of S48 and at least one of S42 and S43, wherein the condition-node processing component (66) is further configured for combining for each condition-node (20) of at least the subset of the condition-nodes (50, 51):
   (a) the condition-node modifier (22) of the respective condition-node (20),
   (b) the condition-node values (24) of all condition-nodes (20) of the subset of condition-nodes (50, 51) which are respectively linked to the respective condition-node (20) by a node-link (40) that is directed towards the respective condition-node (20), and
   (c) the node-link values (42) of the node-links (20) connecting said condition-nodes.
S54 The system according to any of the preceding system embodiments with the features of S50 or S52, wherein at least the subset of the condition-nodes (50, 51) are all condition-nodes (20).
S55 The system according to any of the preceding system embodiments with the features of S50 or S52, wherein the node-links (20) are the node-links of at least a subset of node-links (54, 55).
S56 The system according to any of the preceding system embodiments with the features of S14, wherein the first data-processing system (10) comprises the condition-state determining component (62).
S57 The system according to any of the preceding system embodiments with the features of S15, wherein the first data-processing system (10) comprises the condition-state processing component (64).
S58 The system according to any of the preceding system embodiments with the features of S16, wherein the first data-processing system (10) comprises the condition-node processing component (66).
S59 The system according to any of the preceding system embodiments, wherein the system is configured for receiving input data that indicate at least a part or all of the condition-states (30) of the subset(s) of the condition-states (52, 53).
S60 The system according to the preceding system embodiment, wherein the system is further configured to for storing the subset(s) of the condition-states (52,53) according to the input data that indicate at least the part or all of the condition-states (30) in said subset(s).
S61 The system according to any of the preceding system embodiments with the features of S17, wherein the input-processing component (68) and/or the system is configured for determining the subset(s) of the condition-states (52, 53) based on the input data that indicate at least a part or all of the condition-states of said subset(s).
S62 The system according to any of the preceding system embodiments with the features of S17 and S59, wherein
   the input data indicating at least the part or all of the condition-states (30) of the subset(s) of condition-states (52, 53) comprise at least one or a plurality of groups of condition-states (30), and
   the input processing component (68) is configured for merging the at least one or the plurality of groups of condition-states (30) to obtain the subset(s) of the condition-states (52, 53).
S63 The system according to any of the preceding system embodiments, wherein the second data-processing system (14, 15) is configured to receive the input data that indicate at least a part or all of the condition-states (30) of the subset(s) of the condition-states (52, 53).
S64 The system according to any of the preceding system embodiments, wherein the system is configured for receiving input-data that indicate at least a part or all of the condition-nodes (20) of the subset of the condition-nodes (50, 51).
S65 The system according to any of the preceding system embodiments with the features of S37 and S64, wherein the data-storage component (80) is configured for storing the subset of the condition-nodes (50, 51) according to the received input data that indicate at least the part or all of the condition-nodes (20).
S66 The system according to any of the preceding system embodiments with the features of S17, wherein the system and/or the input-processing component (68) is configured for determining the subset(s) of the condition-nodes (50, 51) based on the input data that indicate at least a part or all of the condition-nodes (20) of said subset(s).
S67 The system according to any of the preceding system embodiments with the features of S17 and S64, wherein
   the input data indicating at least the part or all of the condition-nodes (20) of the subset(s) of condition-nodes (50, 51) comprise at least one or a plurality of groups of condition-nodes (20), and
   the input processing component (68) is configured for merging the at least one or the plurality of groups of condition-nodes (20) to obtain the subset(s) of the condition-nodes (50, 51).
S68 The system according to any of the preceding system embodiments with the features of S17 and S64, wherein
   the input data indicating at least the part or all of the condition-nodes (20) of the subset(s) of condition-nodes (50, 51) comprise at least one or a plurality of groups of condition-nodes (20), and
   the system is configured for merging the at least one or the plurality of groups of condition-nodes (20) to obtain the subset(s) of the condition-nodes (50, 51).
S69 The system according to any of the preceding system embodiments, wherein the second data-processing system (14, 15) is configured to receive the input data that indicate at least a part or all of the condition-nodes (20) of the subset(s) of the condition-states (50, 51).
S70 The system according to any of the preceding system embodiments with the features of S64 and S59, wherein the input data that indicate at least a part or all of the condition-nodes (20) of the subset(s) of the condition-states (50, 51) comprise the input data that indicate at least a part or all of the condition-states (30) of the subset(s) of the condition-states (52, 53).
S71 The system according to any of the preceding system embodiments with the features of S59, wherein the system and/or the input processing component (68) is configured for determining the subset(s) of the condition-nodes (50, 51) based on the input data that indicate at least a part or all of the condition-states (30) of the subset(s) of the condition-states (52, 53).
S72 The system according to any of the preceding system embodiments, wherein the system is further configured for receiving input data that indicate at least a part or all of the node-links (40) of the subset(s) of the node-links (54, 55).
S73 The system according to the preceding system embodiment and with the features of S39, wherein the data storage component (80) is configured to store the subset(s) of the node-links (54, 55) indicated by the input data indicating said subset(s).
S74 The system according to any of the preceding system embodiments with the features of S17, wherein the system and/or the input-processing component (68) is configured for determining the subset(s) of the node-links (54, 55) based on the input data that indicate at least a part or all of the node-links of said subset(s).
S75 The system according to any of the preceding system embodiments with the features of S17 and S72, wherein
   the input data indicating at least the part or all of the node-links (40) of the subset(s) of the node-links (54, 55) comprise at least one or a plurality of groups of node-links (40), and
   the input processing component (68) is configured for merging the at least one or the plurality of groups of node-links (40) to obtain the subset(s) of the node-links (54, 55).
S76 The system according to any of the preceding system embodiments with the features of S17 and S72, wherein
   the input data indicating at least the part or all of the node-links (40) of the subset(s) of the node-links (54, 55) comprise at least one or a plurality of groups of node-links (40), and
   the input processing component (68) is configured for merging the at least one or the plurality of groups of node-links (40) to obtain the subset(s) of the node-links (54, 55).
S77 The system according to any of the preceding system embodiments, wherein the second data-processing system (14, 15) is configured to receive the input data that indicate at least a part or all of the node-links (40) of the subset(s) of the node-links (54, 55).
S78 The system according to any of the preceding system embodiments, wherein the system is further configured for receiving input data that indicate at least a part or all of the condition-state values (36).
S79 The system according to the preceding system embodiment, wherein the system is further configured for receiving at least a portion of the input data that indicate at least a part or all of the condition-state values (36) from a data-processing system.
S80 The system according to any of the preceding system embodiments with the features of S78, wherein the system is configured for receiving at least a portion of the input data that indicate at least a part or all of the condition-state values (36) from at least one or a plurality of sensing devices.
S81 The system according to any of the preceding system embodiments, wherein the system is configured for outputting data.
S82 The system according to any of the preceding system embodiments, wherein the system is configured for outputting at least one of
   condition-node values (24) of the condition-nodes (20),
   node-links (40) linking the condition-nodes (20),
   comparison results (38) of the condition-states (30).
S83 The system according to any of the preceding system embodiments, wherein the system is configured for outputting at least one of
   condition-node values (24) of the condition-nodes (20) of the subset(s) of condition-nodes (50, 51),
   node-links (40) linking the condition-nodes (20) of the subset(s) of the condition-nodes (50, 51),
   comparison results (38) of the condition-states (30) of the subset(s) of the condition-states (52, 53).
S84 The system according to any of the preceding system embodiments with the features of S19 and S81, wherein the system is configured for outputting at least a portion or all of the data to be outputted to at least one of the at least one user interface (82).
S85 The system according to any of the preceding system embodiments with the features of S19 and S81,wherein the second data-processing system (14, 15) is configured for transmitting at least a portion or all of the data to be outputted to the at least one of the at least one user interface (82).
S86 The system according to any of the preceding system embodiments with the features of S81, wherein the second data-processing system (14, 15) is configured for processing at least a portion or all of the data to be outputted.
S87 The system according to any of the preceding system embodiments with the features of S81, wherein the system is configured for outputting at least a portion or all of the data to be outputted by transmitting them to a third data-processing system.
S88 The system according to the preceding system embodiment, wherein the first data-processing system (10) is configured to transmit said at least the portion or all of the data to be outputted.
S89 The system according to any of the preceding system embodiments with the features of S81, wherein the data to be outputted comprise at least one of condition-nodes (20) and condition-states (30) that are linked by one or more node-links (40) to at least one of a specified condition-node (20) and a specified condition-state (30).
S90 The system according to the preceding embodiment and with the features of S18, wherein the system and/or the output-determining component (82) is configured for determining said at least one of condition-nodes (20) and condition-states (30) that are linked by one or more node-links (40) to at least one of a specified condition-node (20) and a specified condition-state (30).
S91 The system according to any of the preceding system embodiments with the features of S81, wherein the data to be outputted comprise at least one of condition-nodes (20) and condition-states (30) to be outputted that are each linked to at least one of a specified condition-node (20) and a specified condition-state (30) according to at least one of at least one or a plurality of linking criteria.
S92 The system according to any of the preceding system embodiments with the features of S81 and S18, wherein the output-determining component (70) is configured for determining at least one of condition-nodes (20) and condition-states (30) to be outputted that are each linked to at least one of a specified condition-node (20) and a specified condition-state (30).
S93 The system according to the preceding system embodiment, wherein the data to be outputted comprise the data determined by the output-determining component (70).
S94 The system according to any of the two preceding system embodiments, wherein the system is configured to output data determined by the output-determining component (70).
S95 The system according to any of the preceding system embodiments with the features of S63 and S18, wherein the output-determining component (70) is configured for determining condition-nodes (20) to be outputted based on a specified condition-node (20), wherein the specified condition-node (20) is reachable from each of the condition-nodes (20) to be outputted by the node-links (40).
S96 The system according to any of the preceding system embodiments with the features of S63 and S18, wherein the output-determining component (70) is configured for determining condition-states (30) to be outputted based on a specified condition-node (20), wherein each condition-state (30) to be outputted is assigned to the specified condition-node (20).
S97 The system according to any of the preceding system embodiments with the features of S64 and S18, wherein the output-determining component (70) is configured for determining condition-states (30) to be outputted based on a specified condition-node (20), wherein each condition-state (30) to be outputted is either assigned to the specified condition-node (20) or assigned to a condition-node (20) from which the specified condition-node (20) is reachable by the node-links (40).
S98 The system according to any of the preceding system embodiments with the features of S64 and S18, wherein the output-determining component (70) is configured for determining condition-nodes (20) to be outputted based on a specified condition-node (20), wherein each of the condition-nodes (20) to be outputted is reachable from the specified condition-node (20) by the node-links (40).
S99 The system according to any of the preceding system embodiments with the features of S64 and S18, wherein the output-determining component (70) is configured for determining condition-nodes (20) to be outputted based on a specified condition-state (30), wherein the specified condition-state (30) is assigned to each of the condition-nodes (20) to be outputted.
S100 The system according to any of the preceding system embodiments with the features of S64 and S18, wherein the output-determining component (70) is configured for determining condition-nodes (20) to be outputted based on a specified condition-state (30), wherein for each of the condition-nodes (20) to be outputted, either the specified condition-state (30) is assigned to said condition-node (20), or the specified condition-state (30) is assigned to a condition-node (20) from which the respective condition-node (20) to be outputted is reachable by the node-links (40).
S101 The system according to any of the preceding system embodiments with the features of at least one of the embodiments S92 to S100, wherein the output-determining component (70) is configured to determine the condition-nodes (20) to be outputted, which condition-nodes belong to a specified subset of the condition-nodes (50, 51).
S102 The system according to any of the preceding system embodiments with the features of at least one of the embodiments S92 to S101, wherein the output-determining component (70) is configured to determine the condition-states (30) to be outputted, which condition-states belong to a specified subset of the condition-states (52, 53).
S103 The system according to any of the preceding system embodiments with the features of S101 and/or S102, wherein the output-determining component (70) is configured to perform the determining for each of a plurality of subsets of condition-nodes (50, 51) and/or condition-states (52, 53).
S104 The system according to any of the preceding system embodiments with the features of at least one of the embodiments S92 to S103, wherein the output-determining component (70) is configured to perform the determining based on at least one of the specified condition-node (20) and the specified condition-state (30) for each of a plurality of specified condition-nodes (20) and/or specified condition-states (30) respectively.
S105 The system according to any of the preceding embodiments with the features of at least one of S92 to S104, wherein the system is configured to output the condition-nodes (20) and/or condition-states (30) to be outputted.
S106 The system according to any of the preceding embodiments with the features of at least one of S92 to S105, wherein the system is configured to output the condition-node values (24) and/or the condition-state values (36) corresponding to the condition-nodes (20) and/or condition-states (30) to be outputted.
S107 The system according to any of the preceding system embodiments with the features of S21, wherein the pre-calculating (74) component is configured for performing pre-calculations of for at least a portion of the data to be outputted and to thus generate pre-calculated data.
S108 The system according to any of the preceding system embodiments with the features of S21 and S92, wherein the pre-calculating (74) component is configured for pre-calculating at least a portion of the at least one of the condition-nodes (20) and the condition-states (30) to be outputted that are each linked to at least one of a specified condition-node (20) and a specified condition-state (30).
S109 The system according to the preceding system embodiment, wherein the pre-calculating component (74) is configured for pre-calculating the at least one of the condition-nodes (20) and the condition-states (30) to be outputted for a plurality of different specified condition-nodes (20) and/or condition-states (30).
S110 The system according to the preceding system embodiment, wherein the pre-calculating component (74) is configured for pre-calculating the at least one of the condition-nodes (20) and the condition-states (30) to be outputted for each possible specified condition-nodes (20) and/or condition-states (30).
S111 The system according to any of the preceding system embodiments with the features of S107, wherein the system is further configured for storing the pre-calculated data.
S112 The system according to any of the preceding system embodiments with the features of S107, wherein the data-storage component (80) is further configured for storing the pre-calculated data.
S113 The system according to any of the preceding system embodiments with the features of S107, wherein the system is configured to transmit the pre-calculated data to the second data-processing system (14, 15).
S114 The system according to any of the preceding system embodiments with the features of S107 and S92, wherein the output-determining component (70) is configured to determine at least a portion of the condition-states (30) and/or condition-nodes (20) based on the pre-calculated data.
S115 The system according to any of the preceding system embodiments with the features of S107 and S92, wherein the second data-processing system (14, 15) is configured to determine at least a portion of the condition-states (30) and/or condition-nodes (20) based on the pre-calculated data.
S116 The system according to any of the preceding embodiments with the features of at least one of S106 and S107, wherein the system is configured to output the condition-node values (24) and/or the condition-state values (36) corresponding to the condition-nodes (20) and/or condition-states (30) to be outputted determined based on the pre-calculated data.
S117 The system according to any of the preceding embodiments with the features of at least one of S106 and S107, wherein the second data-processing system (14, 15) is configured to output the condition-node values (24) and/or the condition-state values (36) corresponding to the condition-nodes (20) and/or condition-states (30) to be outputted based on the pre-calculated data.
S118 The system according to any of the preceding system embodiments with the features of S107, wherein the data-storage component is configured to store the pre-calculated data.
S119 The system according to any of the preceding system embodiments with the features of S107, wherein the data-storage component is configured to store the pre-calculated data in a graph-database.
S120 The system according to any of the preceding system embodiments with the features of S107, wherein the data-storage component is configured to store the pre-calculated data in a document-oriented database.
S121 The system according to any of the preceding system embodiments with the features of S107, wherein the data-storage component is configured to store the pre-calculated data in source code of an application for operating the system.
S122 The system according to any of the preceding system embodiments, wherein the at least one second data processing system (14, 15) is a plurality of second data processing systems (14, 15).
S123 The system according to the preceding system embodiment and with the features of S37 and S38, wherein the data-storage component (80) is configured for storing at least an indicator of one subset of the condition-nodes (50, 51) and of one of the condition-states (52,53) for each of the second data processing systems (14, 15).
S124 The system according to the preceding system embodiment, wherein the system is further configured to store and process for each second data-processing system (14, 15) a set of condition-node values (24).
S125 The system according to any of the two preceding system embodiments, wherein the system is further configured to store and process for each second data-processing system (14, 15) a set of condition-state values (36).
S126 The system according to any of the three preceding system embodiments, wherein the system is further configured to store and process for each second data-processing system (14, 15) a set of comparison results (38).
S127 The system according to any of the three preceding system embodiments, wherein the system is further configured to store and process for each second data-processing system (14, 15) a set of condition-state thresholds (34).
S128 The system according to any of the preceding system embodiments, wherein the system is a risk-management system.
S129 The system according to any of the preceding system embodiments, wherein the system is a system for risk assessment.
S130 The system according to any of the preceding system embodiments, wherein the system is a system for risk assessment of a system.
S131 The system according to any of the preceding system embodiments, wherein the system is a system for risk assessment of an IT-system.
S132 The system according to any of the preceding system embodiments, wherein the system is a system for risk assessment of a financial service provider.
S133 The system according to any of the preceding system embodiments, wherein the system is a system for risk assessment of a data processing facility.
S134 The system according to any of the preceding system embodiments, wherein the system is a system for risk assessment of a production system.
S135 The system according to any of the preceding system embodiments, wherein the system is a system for risk assessment of an organisation.
S136 The system according to any of the preceding system embodiments, wherein the system is a system for risk assessment of a vessel.
S137 The system according to any of the preceding system embodiments, wherein the system is a system for risk assessment of an aircraft.

Below, method embodiments will be discussed. These embodiments are abbreviated by the letter “M” followed by a number. Whenever reference is herein made to “method embodiments”, these embodiments are meant.
M1 A computer-implemented method, comprising
   using at least one of a first data-processing system (10) and a second data-processing system (14, 15) to perform the method,
   storing a plurality of condition-nodes (20) and at least one condition-state (30), wherein each condition-state (30) is assigned to at least one condition-node (20),
   storing at least one node-link(s) (40), wherein each node-link (40) connects two condition-nodes (20), and
   a condition-state determining step (CSD), comprising for each condition-state (30) of at least a subset of the condition-states (52, 53) generating a value and assigning this generated value to the respective condition-state (30).
M2 The computer-implemented method according to any of the preceding method embodiments, further comprising a condition-state processing step (CSP), comprising for each condition-node (20) of at least the subset of the condition nodes (50, 51) aggregating the values assigned to the condition-states (30) relating to the respective condition-node (20) and thus generating a condition-node modifier (22) for each condition-node (20).
M3 The computer-implemented method according to any of the preceding method embodiments, wherein each of the node-links (40) is directed.
M4 The computer-implemented method according to any of the preceding method embodiments, wherein each condition state comprises a condition-state threshold (34) and a condition-state value (36).
M5 The computer-implemented method according to the preceding method embodiment, wherein in the condition-state determining step (CSD), for each condition state (30) of at least the subset of the condition states (52, 53),
   the generating of the value comprises comparing the respective condition-state value (36) and the respective condition-state threshold (34) and thus generating a respective comparison result (38),
   said respective comparison result (38) corresponds to the respective value, and
   assigning said respective value to the respective condition-state (30) comprises assigning the comparison result (38) to the respective condition-state (30).
M6 The computer-implemented method according to the preceding method embodiment, wherein in the condition-state processing step (CSP), aggregating the values assigned to the condition-states (30) comprises aggregating the comparison results (38) of the respective condition states (30).
M7 A computer-implemented method, comprising
   using at least one of the first data-processing system (10) and the second data-processing system (14, 15) to perform the method,
   storing the plurality of the condition-nodes (20) and the at least one condition-state (30),
      wherein each condition-state (30) is assigned to at least one condition-node (20), and wherein each condition-state (30) comprises
         a condition-state threshold (34) and
         a condition-state value (36)
   storing the at least one node-link(s) (40), wherein each node-link (40) connects two condition-nodes (20) and each node-link (40) is directed,
   the condition-state determining step (CSD), comprising for each condition-state (30) of at least a subset of the condition-states (52, 53)
      comparing the respective condition-state value (36) and the respective condition-state threshold (34) and thus generating a respective comparison result (38), and
      assigning the comparison result (38) to the respective condition-state (30)
   a condition-state processing step (CSP), comprising for each condition-node (20) of the subset of the condition nodes (50, 51) aggregating the comparison results (38) of the condition-states (30) of the subset of the condition-states (52, 53) relating to the respective condition-node (20) and thus generating a condition-node modifier (22) for the respective condition-node (20).
M8 The method according to any of the preceding method embodiments with the features of M5 or M7, wherein comparing the respective condition-state value (36) and the respective condition-state threshold (34) and thus generating a respective comparison result (38) comprises calculating a distance of the respective condition-state value (36) and the respective condition-state threshold (34).
M9 The method according to any of the preceding method embodiments with the features of M5 or M7, wherein comparing the respective condition-state value (36) and the respective condition-state threshold (34) and thus generating a respective comparison result comprises limiting the respective comparison result to a certain range of values.
M10 The method according to any of the preceding method embodiments, comprising a condition-node processing step (CNP), wherein the condition-node processing step (CNP) comprises for each condition-node (20) of the subset of the condition-nodes (50, 51) generating a condition-node value (24) and assigning this condition-node value (24) to the respective condition-node (20).
M11 The method according to the preceding method embodiment and with the features of M3 or M7, wherein the step of generating the condition-node value (24) for each condition-node (20) of at least the subset of the condition-nodes (50, 51) comprises combining
   the condition-node modifier (22) of the respective condition-node (20), and
   the condition-node value (24) of each condition-node (20) of the subset of the condition-nodes (50, 51) that is linked to the respective condition-node (20) by a node-link (40) that is directed towards the respective condition-node (20).
M12 The method according to the penultimate method embodiment and with the features of M3 or M7, wherein the step of generating the condition-node value (24) in the condition-node processing step (CNP) comprises combining
   the condition-node modifier (22) of the respective condition-node (20), and
   the condition-node value (24) of each condition-node (20) of the subset of the condition-nodes (50, 51) that is linked to the respective condition node (20) by a node-link (40) that is directed towards the respective condition node (20), wherein each respective condition-node value (24) is combined with a node-link value (42) associated with the respective node-link (40).
M13 The method according to the preceding method embodiment and with the features of M10 and at least one of M3 and M7, wherein the step of generating the condition-node value (24) for each condition-node (20) of the subset of the condition-nodes (50, 51) comprises combining
   the condition-node modifier (22) of the respective condition-node (20), and
the condition-node value (24) of each condition-node (20) of the subset of the condition-nodes (50, 51) that is linked to the respective condition node (20) by a node-link (40) from a subset of the node-links (54, 55) and which node-link is directed towards the respective condition node (20).
M14 The method according to the penultimate method embodiment and with the features of M3 or M7, wherein the step of generating the condition-node value (24) in the condition-node processing step (CNP) comprises combining
   the condition-node modifier (22) of the respective condition-node (20), and
   the condition-node value (24) of each condition-node (20) of the subset of the condition-nodes (50, 51) that is linked to the respective condition node (20) by a node-link (40) from the subset of the node-links (54, 55) and which node-link is directed towards the respective condition node (20), wherein each respective condition-node value (24) is combined with a node-link value (42) associated with the respective node-link (40).
M15 The method according to any of the preceding method embodiments with the features of M10 or M11, wherein the condition-node processing step (CNP) is performed by the first data-processing system (10).
M16 The method according to any of the preceding method embodiments, wherein the method further comprises a condition-state selecting step (CSS), wherein the condition-state selecting step (CSS) comprises receiving input data that indicate at least a part or all of the condition-states (30) of the subset of the condition-states (52, 53).
M17 The method according to the preceding method embodiment, wherein the condition-state selecting step (CSS) comprises furthermore storing the subset of the condition-states (52, 53) according to the received input data that indicate at least the part or all of the condition-states (30).
M18 The method according to the any of the two preceding method embodiments, wherein the received input data that indicate at least the part or all of the condition-states (30) comprise data that indicate at least one or a plurality of groups of condition-states (30), and wherein the condition-state selecting step (CSS) comprises merging the at least one or the plurality of groups of condition-states (30) to obtain the subset of the condition-states (52, 53).
M19 The method according to any of the preceding method embodiments with the features of M16, wherein receiving the input data that indicate at least a part or all of the condition-states (30) of the subset of the condition-states (52, 53) is performed by the second data-processing system (14, 15).
M20 The method according to any of the preceding method embodiments with the features of M2 or M7, wherein the method further comprises a condition-node selecting step (CNS), wherein the condition-node selecting step (CNS) comprises receiving input data that indicate at least a part or all of the condition-nodes (20) of the subset of the condition-nodes (50, 51).
M21 The method according to the preceding method embodiment, wherein the condition-node selecting step (CNS) comprises furthermore storing the subset of the condition-nodes (50, 51) according to the received input data that indicate at least the part or all of the condition-nodes (20).
M22 The method according to any of the preceding method embodiments with the features of M20, wherein the input data that indicate at least the part or all of the condition-nodes (20) of the subset of the condition-nodes (50, 51) comprise data that indicate at least one or a plurality of groups of condition-nodes (20), and wherein the condition-node selecting step (CNS) comprises merging the at least one or the plurality of groups of condition-nodes (20) to obtain the subset of the condition-nodes (50, 51).
M23 The method according to any of the preceding method embodiments with the features of M20, wherein receiving the input data that indicate at least a part or all of the condition-nodes (20) of the subset of the condition-states (50, 51) is performed by the second data-processing system (14, 15).
M24 The method according to any of the preceding method embodiments with the features of M16 and M20, wherein the input data that indicate at least a part or all of the condition-nodes (20) of the subset of the condition nodes (50, 51) comprise the input data that indicate at least a part or all of the condition-states (30) of the subset of the condition-states (52, 53).
M25 The method according to any of the preceding embodiments with the features of M16 and M20, wherein the condition-node selecting step (CNS) further comprises selecting condition-nodes (20) based on the input data that indicate at least a part or all of the condition-states (30) of the subset of the condition-states (52, 53).
M26 The method according to any of the preceding method embodiments, wherein the method further comprises a node-link selecting step (NLS), wherein the node-link selecting step (NLS) comprises receiving input data that indicate at least a part or all of the node-links (40) of the subset of the node-links (54, 55).
M27 The method according to the preceding method embodiment, wherein the node-link selecting step (NLS) comprises furthermore storing the subset of the nodes (54, 55) according to the received input data that indicate at least the part or all of the node-links (40).
M28 The method according to any of the preceding method embodiments with the features of M26, wherein the input data that indicate at least the part or all of the node-links (40) of the subset of the node-links (54, 55) comprise data that indicate at least one or a plurality of groups of node-links (40), and wherein the node-link selecting step (NLS) comprises merging the at least one or the plurality of groups of node-links (40) to obtain the subset of the node-links (54, 55).
M29 The method according to any of the preceding method embodiments with the features of M26, wherein receiving the input data that indicate at least a part or all of the node-links (40) of the subset of the node-links (54, 55) is performed by the second data-processing system (14, 15).
M30 The method according to any of the preceding method embodiments, wherein the method further comprises a condition-state value receiving step (CSV), wherein the condition-state value receiving step (CSV) comprises receiving input data that indicate at least a part of the condition-state values (36).
M31 The method according to any of the preceding method embodiments with the features of M30, wherein receiving input data that indicate at least a part of the condition-state values (36) comprises receiving input data from a data-processing system.
M32 The method according to any of the preceding method embodiments with the features of M30, wherein receiving input data that indicate at least a part of the condition-state values (36) comprises receiving input data from at least one or a plurality of sensing devices.
M33 The method according to any of the preceding method embodiments, wherein the method further comprises an outputting step (OS) that comprises outputting data.
M34 The method according to M33, wherein in the outputting step, the outputting data comprises outputting at least one of 1

condition-node values (24) of the condition nodes (20) of the subset of the condition nodes (50, 51)
node-links linking the condition nodes (20) of the subset of the condition nodes (50, 51)
comparison results (38) of the condition-states (30) of the subset of the condition states (52, 53).
M35 The method according to any of the preceding method embodiments with the features of M33, wherein in the outputting step, the outputting comprises outputting at least a part or all of the respective data to a user interface and said outputting to the user interface is performed by the second data-processing system (14, 15).
M36 The method according to any of the preceding method embodiments with the features of M33, wherein in the outputting step, the outputting comprises at least one of storing at least a part or all of the respective data by the second data-processing system (14, 15) and/or processing at least a part or all of the respective data by the second data-processing system (14,15).
M37 The method according to any of the preceding method embodiments with the features of M33, wherein in the outputting step, the outputting comprises transmitting at least a part or all of the respective data to a third data-processing system and said transmitting to the third data-processing system is performed at least partially by the first data-processing system (14, 15).
M38 The method according to any of the preceding embodiments with the features of M33, wherein in the outputting step, the outputting data comprises outputting at least one of condition-nodes (20) and condition-states (30) that are linked to at least one of a specified condition-node (20) and a specified condition-state (30).
M39 The method according to any of the preceding embodiments with the features of M33, wherein in the outputting step, the outputting data comprises outputting at least one of condition-nodes (20) and condition-states (30) to be outputted that are each linked to at least one of a specified condition-node (20) and a specified condition-state (30) according to a linking-criterion.
M40 The method according to any of the preceding embodiments with the features of M39, wherein the linking-criterion is a linking criterion for outputting condition-nodes (20) based on a specified condition-node (20) and the linking-criterion comprises that there is a set of node-links (40) connecting each condition-node (20) to be outputted to the specified condition-node (20) in the sense of the node-links.
M41 The method according to any of the preceding embodiments with the features of M39, wherein the linking-criterion is a linking criterion for outputting condition-states (30) based on a specified condition-node (20) and the linking-criterion comprises that each condition state (30) to be outputted is assigned to the specified condition-node (20).
M42 The method according to any of the preceding embodiments with the features of M39, wherein the linking-criterion is a linking criterion for outputting condition-states (30) based on a specified condition-node (20) and the linking-criterion comprises that each condition state (30) to be outputted is connected to the specified condition-node (20) at least indirectly.
M43 The method according to any of the preceding embodiments with the features of M39, wherein the linking-criterion is a linking criterion for outputting condition-nodes (20) based on a specified condition-node (20) and the linking-criterion comprises that there is a set of node-links (40) connecting the specified condition-node (20) to each condition-node (20) to be outputted in the sense of the node-links. 0

M44 The method according to any of the preceding embodiments with the features of M39, wherein the linking-criterion is a linking criterion for outputting condition-nodes (20) based on a specified condition-state (30) and the linking-criterion comprises that the specified condition state (30) is assigned to each condition-node (20) to be outputted.
M45 The method according to any of the preceding embodiments with the features of M39, wherein the linking-criterion is a linking criterion for outputting condition-nodes (20) based on a specified condition-state (30) and the linking-criterion comprises that each condition-node (20) to be outputted is connected to the specified condition-state (30) at least indirectly.
M46 The method according to any of the preceding embodiments with the features of M39, wherein the method comprises performing the outputting step for a plurality of different linking criteria, specified condition-states and/or specified condition-nodes.
M47 The method according to any of the preceding method embodiments with the features of M39 and M10, wherein the outputting step comprises outputting at least one or a plurality of condition-node values (24) of the condition-nodes (20) to be outputted.
M48 The method according to any of the preceding method embodiments with the features of M39 and M4 or M7, wherein the outputting step comprises outputting at least one or a plurality of condition-state values (36) of the condition-states (30) to be outputted.
M49 The method according to any of the preceding method embodiments with the features of M39, wherein the method comprises a pre-calculating step (PCS) that comprises determining at least one of the condition-nodes (20) and the condition-states (30) to be outputted for at least one or a plurality of linking-criteria and a plurality of the at least one of the specified condition-node (20) and the specified condition-state (30) and to thus generate pre-calculated data.
M50 The method according to the preceding embodiment, wherein the pre-calculating step (PCS) comprises further storing said pre-calculated data.
M51 The method according to any of the preceding method embodiments with the features of M49, wherein the pre-calculating step (PCS) is performed by the first data-processing system (10).
M52 The method according to any of the preceding method embodiments with the features of M49, wherein the pre-calculated data are stored at least at the second data-processing system (14,15).
M53 The method according to any of the preceding method embodiments with the features of M49 and M33, wherein the outputting data is based on the pre-calculated data.
M54 The method according to the two preceding method embodiments and with the features of M47 or M48, wherein the method comprises determining the at least one of the plurality of the condition-node values (24) and the condition-state values (36) based at least on the pre-calculated data.
M55 The method according to the antepenultimate and the penultimate method embodiments and with the features of M47 or M48, wherein the method comprises determining the at least one of the plurality of the condition-node values (24) and the condition-state values (36) by the second data-processing system (14, 15).
M56 The method according to any of the preceding method embodiments, wherein storing the at least one node-link(s) (40) and storing the plurality of the condition-nodes (20) comprises storing the at least one node-link(s) (40) and storing the plurality of the condition-nodes (20) in a graph database.
M57 The method according to any of the preceding method embodiments, wherein storing the at least one condition state (30) comprises storing the at least one condition state (30) in a document-oriented database.
M58 The method according to any of the preceding method embodiments with the features of M49, wherein the method comprises storing the pre-calculated data in a graph database.
M59 The method according to any of the preceding method embodiments with the features of M49, wherein the method comprises storing the pre-calculated data in a document-oriented database.
M60 The method according to any of the preceding method embodiments with the features of M49, wherein the method comprises storing the pre-calculated data in source code of an application for carrying out the method and furthermore compiling said source code.
M61 The method according to any of the preceding method embodiments, wherein the method comprises
   using the first data-processing system (10) and a plurality of second data-processing systems (14, 15),
   performing the condition-state determining step (CSD) for each second data-processing system (14, 15), wherein each subset of the condition-states (52, 53) corresponds to at least one or exactly one second data-processing system (14, 15), and
   performing the condition-state processing step (CSP) for each second data-processing system (14, 15), wherein each subset of the condition-nodes (50, 51) corresponds to at least one second data-processing system (14, 15), and wherein the method comprises furthermore
   storing separate sets of values for the condition-node values (24), the condition-node modifiers (22), the condition-state values (36) and the comparison results (38) for each second data-processing system (14, 15).
M62 The method according to any of the preceding method embodiments with the features of M61 and M10, wherein the method comprises furthermore performing the condition-node processing step (CNP) for each set of the sets of values, wherein each condition-node processing step (CNP) is according to embodiment M10 or any of its depending embodiments.
M63 The method according to any of the preceding method embodiments with the features of M61 and M16, wherein the method comprises furthermore performing the condition-state selecting step (CSS) for each set of the sets of values, wherein each condition-state selecting step (CSS) is according to embodiment M16 or any of its depending embodiments.
M64 The method according to any of the preceding method embodiments with the features of M61 and M20, wherein the method comprises furthermore performing the condition-node selecting step (CNS) for each set of the sets of values, wherein each condition-node selecting step (CNS) is according to embodiment M20 or any of its depending embodiments.
M65 The method according to any of the preceding method embodiments with the features of M61 and M30, wherein the method comprises furthermore performing the condition-state value receiving step (CSV) for each set of the sets of values, wherein each condition-state value receiving step (CSV) is according to embodiment M30 or any of its depending embodiments.
M66 The method according to any of the preceding method embodiments with the features of M61 and M33, wherein the method comprises furthermore performing the outputting step (OS) for each set of the sets of values, wherein each outputting step (OS) is according to embodiment M33 or any of its depending embodiments.
M67 The method according to any of the preceding method embodiments, wherein the method is a method for risk assessment.
M68 The method according to any of the preceding method embodiments, wherein the method is a method for risk assessment of a system.
M69 The method according to any of the preceding method embodiments, wherein the method is a method for risk assessment of an IT-system.
M70 The method according to any of the preceding method embodiments, wherein the method is a method for risk assessment of a financial service provider.
M71 The method according to any of the preceding method embodiments, wherein the method is a method for risk assessment of a data processing facility.
M72 The method according to any of the preceding method embodiments, wherein the method is a method for risk assessment of a production system.
M73 The method according to any of the preceding method embodiments, wherein the method is a method for risk assessment of an institution.
M74 The method according to any of the preceding method embodiments, wherein the method is a method for risk assessment of a vessel or an aircraft.
M75 The method according to any of the preceding method embodiments, further comprising using the system according to any of the preceding system embodiments.
S138 The system according to any of the preceding system embodiments, wherein the system is configured to carry out any of the preceding method embodiments.

Below, computer program embodiments will be discussed. These embodiments are abbreviated by the letter “C” followed by a number. Whenever reference is herein made to “method embodiments”, these embodiments are meant.
C1 A computer program comprising instructions causing the system according to any of the system embodiments to execute steps of the method according to any of the method embodiments.
C2 A computer program comprising instructions causing the first data-processing system (10) according to any of the system embodiments to execute the steps of the method according to any of the method embodiments that are to be executed by the first data-processing system (10).
C3 A computer program comprising instructions causing at least one of the at least one second data-processing system (14, 15) according to any of the system embodiments to execute the steps of the method according to any of the method embodiments that are to be executed by the second data-processing system (14, 15).

### SHORT DESCRIPTION OF THE FIGURES

Figures

FIG. 1 shows a part of a general concept of a computer-implemented method

FIG. 2 shows method steps and used data-processing systems of the computer-implemented method

FIG. 3 shows an embodiment of the method for a plurality of second data-processing systems

FIG. 4 shows a detail of an embodiment of the method for a plurality of second data-processing systems

FIG. 5 shows precalculated data relating to condition-nodes from which specified condition-nodes can be reached for a subset of condition-nodes and condition-links

FIG. 6 shows precalculated data relating to condition-nodes from which specified condition-nodes can be reached for another subset of condition-nodes and condition-links

FIG. 7 shows precalculated data relating to condition-states and condition-nodes that impact a value of other condition-nodes

### DETAILED DESCRIPTION OF THE FIGURES

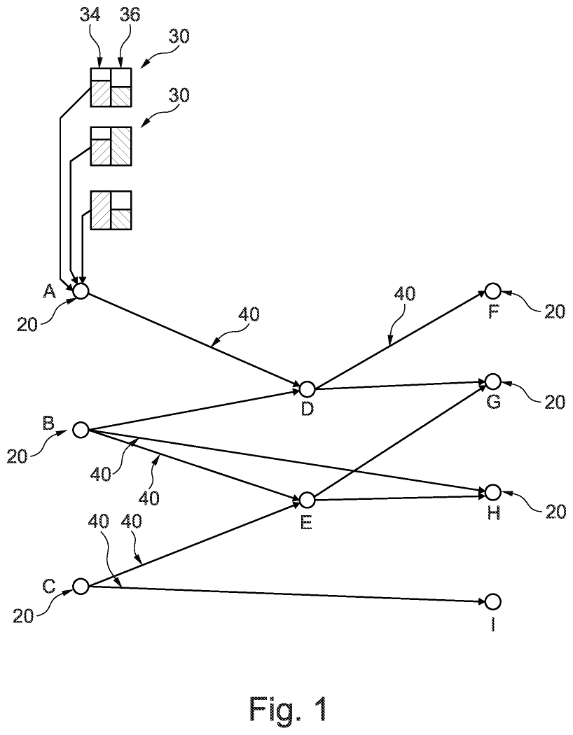

FIG. 1 shows the general concept of the invention. A method comprises using a plurality of condition-nodes 20, in FIG. 1 indicated by capital letters A to I, wherein the number of condition-nodes 20 is merely exemplary. The condition-nodes (20) are connected by node-links 40. The node-links 40 can optionally each be associated with a node-link value 42. The node-links 40 are directed and each node-link 40 links one condition-node 20 to another condition-node 20.

As an example, FIG. 1 shows furthermore a plurality of condition-states 30 that are assigned to one of the condition-nodes 20. Each of the condition-states 30 can also be assigned to at least one or a plurality of other condition-nodes 20, and each or at least some of the condition-states 30 can be assigned to different condition-nodes 20. For the sake of clarity and readability, such further relations of shown condition-nodes 20 as well as further condition-states 30 are not shown. However, the method may comprise using such further relations of condition-states 30 to condition-nodes 20 as well as further condition-states 30. Each condition-state can comprise a condition-state threshold 34 and a condition-state value 36.

In one example, the method can be used to monitor and manage a condition or a plurality of conditions or reliabilities of a ship, or risks relating to the ship. In such this example, a condition-node relates to at least an aspect of a technical system and/or a corresponding risk. For example, a propulsion-system of the ship may comprise at least one internal combustion engine, a transmission system, and a power-output, such as at least one propeller. The transmission system can for example be a combination of at least one electrical generator and at least one electrical motor, typically completed by corresponding power electronics. The transmission system can for example also be a mechanical transmission system as known to the person ordinarily skilled in the art. In this example, condition-node A represents the internal combustion engine of the ship. The shown condition-states 30 relate all at least to said internal combustion engine. A first condition-state 30 can relate to a quantity of fuel that is stored in the fuel tank. This condition-state's 30 condition-state threshold 34 can for example indicate a minimum quantity of fuel, and this condition-state's condition-state value can refer to the carried quantity of fuel. As this example illustrates, the ship (or the overall system, respectively) may be operational, even though condition-state value 36 is below the condition-state threshold 34. Nevertheless, a risk of fuel-shortage on the high seas may be increased. Analogously, a second condition-state 30 can relate to a lubrification system of the ship. The second condition-state 30 can also relate to another condition-node 20, such as the transmission system of the ship, which may also require the lubrification system to be in an operative state. A third condition-state 30 may relate to a controller, such as an ECU of the combustion engine, or to its software. Also one or more condition-nodes 20 may refer to software components, such as a software component operating a RADAR-system of the ship. That is, more generally speaking, condition-states 30 can relate to one or more condition-nodes 20.

The method comprises comparing the condition-state value 36 and the condition-state threshold 34 of condition-states 30. A result of this comparison is a comparison result 38 (not shown). The comparison result can be obtained by different measures. The comparison results 38 can for example be obtained by calculating a difference of each condition-state value 36 and the respective condition-state threshold 34 if the respective condition-state value 36 is lower than the respective condition-state threshold 34 and assigning said result to the respective comparison result 38, and assigning 0 to the respective comparison result 38 otherwise.

The method can furthermore comprise aggregating the comparison results 38 of each condition-state 30 which condition-state is assigned to a condition-node 20 and thus generating a condition-node modifier 22. In FIG. 1, the condition-states 30 assigned to condition-node 20 A are shown, that is, a condition-node modifier 22 of condition-node 20 A can be obtained from aggregating the shown condition-states' 30 comparison results 38.

Returning to the example of using the method for monitoring a ship's condition or risks relating to a ship, the abovementioned exemplary condition-node modifier 22 relates to the ship's internal combustion engine. If said condition-node modifier 22 and the corresponding comparison results 38 are calculated as discussed above, then they can for example be a measure for a risk of a failure or a stoppage of the internal combustion engine. If their calculation is adapted, such as by subtracting the condition-node modifier 22 from another value, such as 1, then the condition-node modifier 22 can represent a reliability of the internal combustion engine. Analogous considerations apply to other condition-nodes, condition-states 30 and related elements. Condition-node 20 D can in this example relate to a generation of electrical power on board, for example in case of a diesel-electric ship. Condition-nodes 20 A and D are linked by a node-link 40, as the generation of electrical power on board depends on the internal combustion engine. Condition-node 20 F and G are then aspects of the ship that depend on the generation of electrical power on board, such as an operation of the propulsion system (in the case of a diesel-electric ship, where the propulsion system comprises electric motors that power propellers or the like), and an availability of electrical systems on board. In general, the node-links 40 do not need to express absolute dependencies, but they can also only indicate a propagation of conditions or risks, such as in case of the exemplary availability of electrical systems on board. Even in case of an interruption of generation of electrical power on board by generators on board, at least a part of the electrical systems on board will still remain operational at least for some time, as they will most probably be linked to batteries, too.

The detailed example illustrates a use of the method as modern tool of engineering, namely for maintenance and naval operation. However, the method is not limited to this application, but can also be used to monitor other systems, for example a ship as discussed above, a cyber-physical system such as an IT-system, or even conditions and risks in an operation of another system, such as a bank or an insurance.

For example, in case of a bank or an insurance, the condition-nodes could for example correspond to risks that contribute to an operations risk, and the condition-states could correspond to measures that are implemented or required in order to limit or control these risks. The method can hence be a computer-implemented method for risk-assessment of a bank, an insurance and/or any company of corporate finance.

In FIG. 1, some condition-nodes 30 F, G, H and I only have node-links 40 incoming from other condition-nodes 30, but no “outgoing” node-links 40.

Thus, the invention allows to efficiently manage, forecast and simulate impacts of adjustments or measures on conditions or states of a system. As the method uses a graph-representation, applicable states, conditions, measures and (inter-)dependencies can be flexibly changed.

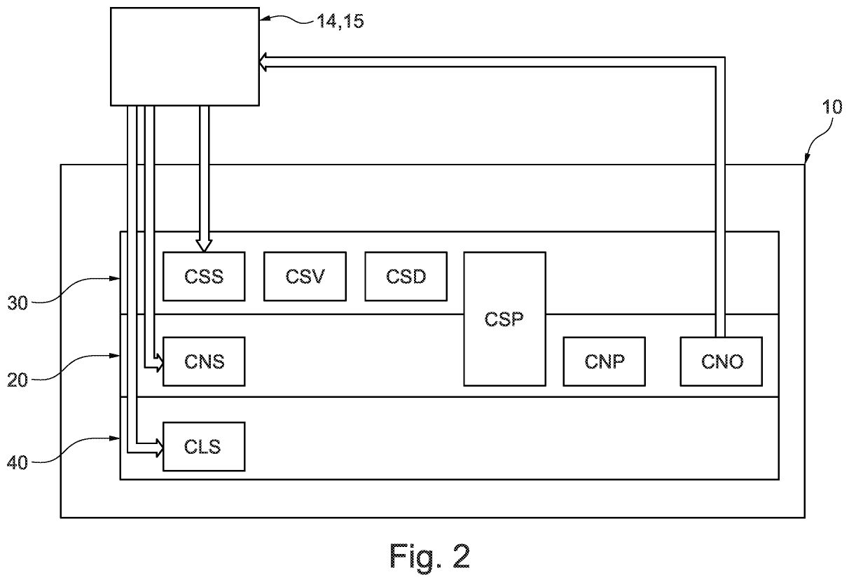

FIG. 2 shows an embodiment of the method with a set of method steps, of which some are optional, and used data-processing systems, comprising a first data-processing system 10 and a second data-processing system 14, 15.

The first data-processing system 10 can for example be a server, a server system, a cloud system, or a hybrid system, wherein calculation operations can be distributed to several devices that may even be end-user computer devices, or a system emulating a server, such as a server system with an appropriate software for running a virtual machine.

The second data-processing system 14, 15 is a data-processing system that comprises at least one user interface. The second data-processing system 14, 15 optionally has a lower computing performance than the first data-processing system 10, or at least computing devices of the second data-processing system 14, 15 optionally have a lower computing performance than the first data-processing system 10. The second data-processing system can for example comprise at least one terminal computer or another end user computer device such as a smart phone.

The first data-processing system 10 may comprise one or more processing units configured to carry out computer instructions of a program (i.e. machine readable and executable instructions). The processing unit(s) of the first data-processing system 10 may be singular or plural. For example, the first data-processing system 10 may comprise at least one of CPU, GPU, DSP, APU, ASIC, ASIP or FPGA. The first data-processing system 10 may comprise memory components, such as, main memory (e.g. RAM), cache memory (e.g. SRAM) and/or secondary memory (e.g. HDD, SDD). The first data-processing system 10 may comprise volatile and/or non-volatile memory such an SDRAM, DRAM, SRAM, Flash Memory, MRAM, F-RAM, or P-RAM. The first data-processing system 10 may comprise internal communication interfaces (e.g. busses) configured to facilitate electronic data exchange between components of the data processing system, such as, the communication between the memory components and the processing components. The first data-processing system 10 may comprise external communication interfaces configured to facilitate electronic data exchange between the data processing system and devices or networks external to the data processing system. For example, the first data-processing system 10 may comprise network interface card(s) that may be configured to connect the data processing system to a network, such as, to the Internet. The first data-processing system 10 may be configured to transfer electronic data using a standardized communication protocol. The first data-processing system 10 may be a centralized or distributed computing system.

To put it simply, the first data-processing system 10 may be a processing unit configured to carry out instructions of a program. The first data-processing system 10 may be a system-on-chip comprising processing units, memory components and busses.

The second data-processing system 14, 15 may comprise one or more processing units configured to carry out computer instructions of a program (i.e. machine readable and executable instructions). The processing unit(s) of the second data-processing system 14, 15 may be singular or plural. For example, the second data-processing system 14, 15 may comprise at least one of CPU, GPU, DSP, APU, ASIC, ASIP or FPGA. The second data-processing system 14, 15 may comprise memory components, such as, main memory (e.g. RAM), cache memory (e.g. SRAM) and/or secondary memory (e.g. HDD, SDD). The second data-processing system 14, 15 may comprise volatile and/or non-volatile memory such an SDRAM, DRAM, SRAM, Flash Memory, MRAM, F-RAM, or P-RAM. The second data-processing system 14, 15 may comprise internal communication interfaces (e.g. busses) configured to facilitate electronic data exchange between components of the second data-processing system 14, 15, such as, the communication between the memory components and the processing components. The second data-processing system 14, 15 may comprise external communication interfaces configured to facilitate electronic data exchange between the data processing system and devices or networks external to the data processing system. For example, the second data-processing system 14, 15 may comprise network interface card(s) that may be configured to connect the data processing system to a network, such as, to the Internet. The second data-processing system 14, 15 may be configured to transfer electronic data using a standardized communication protocol. The data processing system may be a centralized or distributed computing system.

The second data-processing system 14, 15 may comprise user interfaces, such as:
output user interface, such as:
   screens or monitors configured to display visual data,
   speakers configured to communicate audio data,
input user interface, such as:
   camera configured to capture visual data,
   microphone configured to capture audio data,
   keyboard configured to allow the insertion of text and/or other keyboard commands and/or
   trackpad, mouse, touchscreen, joystick.

To put it simply, the second data-processing system 14, 15 may be a processing unit configured to carry out instructions of a program. The second data-processing system 14, 15 may be a system-on-chip comprising processing units, memory components and busses. The data processing system may be a personal computer, a laptop, a pocket computer, a smartphone, a tablet computer. The second data-processing system 14, 15 may be a processing unit or a system-on-chip that may be interfaced with a personal computer, a laptop, a pocket computer, a smartphone, a tablet computer and/or user interfaces (such as the upper-mentioned user interfaces).

In the shown embodiment of the method, at least some steps of the method are executed by the first data-processing system 10. Said steps of the method can be in particular steps whose execution requires many operations, that is, whose execution can be considered to consume much calculation time and/or performance. An optional advantage can be that the first data-processing system 10 can provide a considerably higher computing performance than the second data-processing system 14, 15.

An attribution of steps to data-processing systems 10, 14, 15 as shown in FIG. 2 is to be understood as exemplary. At least one or some steps can optionally also be at least partially performed by the second data-processing system 14, 15, even though shown differently in FIG. 2.

The method comprises storing a plurality of condition-nodes 20, at least one condition-state 30 and at least one node-link 40 together with the other variables such as condition-state thresholds 34, condition-state values 36 and condition-node values 24. These data can be optionally stored on the first data-processing system 10.

The method can comprise at least one or a plurality of optional steps of selecting data. The method can optionally comprise a condition-state selecting step (CSS). The condition-state selecting step (CSS) can comprise selecting a subset of condition-states 52, 53 that is applicable. The subset of condition-states 52, 53 can comprise all condition-states 30. The condition-state selecting step (CSS) can comprise storing said subset 52, 53, wherein this step of storing said subset of condition-states 52, 53 can optionally be performed on the first data-processing system 10.

If, in the subsequently described method steps in the context of FIG. 2, reference is made to “all” condition-states 30 or to “each” condition-state 30, then the condition-states 30 that the subset of condition-states 52, 53 comprises, are meant.

The method can optionally further comprise a condition-node selecting step (CNS). The condition-node selecting step (CNS) can comprise selecting a subset of condition-nodes 50, 51 that is applicable. The subset of condition-nodes 50, 51 can comprise all condition-nodes 20. The condition-node selecting step (CNS) can comprise storing said subset 50, 51, wherein this step of storing said subset of condition-nodes 50, 51 can optionally be performed by the first data-processing system 10.

If, in the subsequently described method steps in the context of FIG. 2, reference is made to “all” condition-nodes 20 or to “each” condition-state 20, then the condition-states 20 that the subset of condition-nodes 50, 51 comprises, are meant.

The method can optionally further comprise a node-link selecting step (NLS). The node-link selecting step (NLS) can comprise selecting a subset of node-links that is applicable. The subset of node-links can comprise all node-links 40. The node-link selecting step (NLS) can comprise storing said subset, wherein this step of storing said subset of node-links can optionally be performed on the first data-processing system 10.

If, in the subsequently described method steps in the context of FIG. 2, reference is made to “all” node-links 40 or to “each” node-link 40, then the node-links 40 that the subset of node-links comprises, are meant.

The abovementioned node-link selecting step (NLS), condition-node selecting step (CNS) and condition-state selecting step (CSS) can comprise receiving input data, such as user input data. A respective part or respective parts of these steps can be performed by the second data-processing system 14, 15. Optionally, also further parts of these steps can be performed by the second data-processing system 14, 15, such as pre-processing input data.

At least one, some or all of the three abovementioned selecting steps may be omitted in some cases, for example if the method is adapted for a standardized system.

The method can optionally further comprise a condition-state value receiving step (CSV). The condition-state value receiving step (CSV) can comprise receiving input data that indicate at least a part of the condition-state values 36. The condition-state value receiving step (CSV) can further comprise pre-processing the input data. The condition-state value receiving step (CSV) can optionally be performed at least partially by the first data-processing system 10. Receiving the input data that indicate at least the part of the condition-state values 36 can optionally at least partially be performed by the second data-processing system 14, 15. Receiving the input data that indicate at least the part of the condition-state values 36 can optionally comprise receiving sensed data, data that are generated by a sensing device and/or data derived from such data.

In some cases, at least one of the previously discussed four steps may comprise receiving data from another data-processing system. That can for example be the case if one of the selecting steps is at least partially automated and/or if one of the selecting steps relies at least partially on data that are already stored by another data-processing system.

The method can further comprise a condition-state determining step (CSD). The condition-state determining step (CSD) can comprise generating respective comparison results 38 for the condition-states 30 or for each condition-state 30 selected in the condition-state selecting step (CSS) as far as applicable, as discussed above. This step can optionally be performed by the first data-processing system 10. Its result(s) can be optionally stored by the first data-processing system 10.

The method can further comprise a condition-state processing step (CSP). The condition-state processing step (CSP) can comprise aggregating for each condition-node 20 all comparison results that are associated to condition-states 30 that relate to the respective condition-node as respective condition-node modifier (22). The condition-state processing step (CSP) can optionally be performed by the first data-processing system 10.

The method can further comprise a condition-node processing step (CNP). The condition-node processing step (CNP) can comprise generating a condition-node value 24 for each condition-node 20. Generating the condition-node value(s) 24 can comprise combining the respective condition-node modifier 22 generated in the condition-state processing step (CSP) and condition-node value(s) 24 of condition-nodes 20 that are linked to the respective condition-node 20 by a node-link 40 that is directed towards the respective condition-node 20. In a case where no condition-node 20 is linked to the respective condition-node 20 by a node-link 40 that is directed towards the respective condition-node 20, the step of combining can optionally be limited respectively to assigning the respective condition-node modifier 22 or a value generated thereof to the condition-node value 24 of the respective condition node 20. In FIG. 1, this would for example apply to the condition-nodes 20 A, B, and C. Furthermore, if the node-links 40 are each associated with a node-link value 42, then the step of combining may further comprise combining or weighting the condition-node values 24 with the respective node-link values 42 of the node-links 40 linking these condition-node values 24 to the respective condition-node 20.

The method can optionally further comprise an outputting step (OS). The outputting step can comprise outputting results of any of the abovementioned method steps. The outputting step (OS) can optionally comprise displaying data by the second data-processing system 14, 15. Outputting results can optionally be or comprise transferring data to another data-processing system.

The outputting step (OS) can comprise outputting at least one of the condition-node values 24 of the condition-nodes 20 of the subset of the condition-nodes 50, 51, the node-links 40 linking the condition-nodes 20 of the subset of the condition-nodes 50, 51, and the comparison results 38 of the conditions-states 30 of the subset of the condition-states 52, 53.

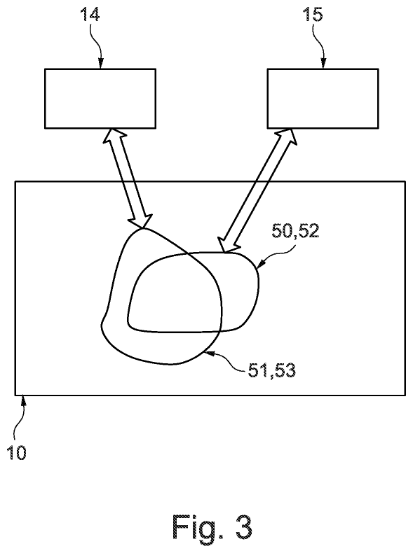

FIG. 3 shows an optional embodiment of the method with two second data-processing systems 14, 15.

Each of the second data-processing systems 14, 15 can be associated with an execution of the method. Therefore, the subsets of the condition-nodes 50, 51 can be specific to each second data-processing system 14, 15. The same applies for each subset of the condition-states 52, 53. In consequence, each subset of the condition-nodes 50, 51 can optionally be associated with a respective subset of the condition-states 52, 53. The same can be applicable for the subsets of the node-links (not shown in FIG. 3).

The abovementioned method steps can respectively be applicable for each set of subsets 50, 52; 51, 53.

The number of second data-processing systems 14, 15 is to be understood as an example. Instead of two second data-processing systems 14, 15 and respective subsets, the method can also comprise a plurality of second data-processing systems, with or without adapted subsets of condition-nodes, conditions-states and node-links.

However, for every second data-processing system, the condition-state values 36 are generated independently from each other. In consequence, the comparison results 38, the condition-node modifiers 22 and the condition-node values 24 are calculated for each second data-processing system 14, 15 depending on the respectively received input data.

The first data-processing system 10 can thus carry out the abovementioned method for a plurality of second data-processing systems 14, 15, that is, for a plurality of applications for which the condition-nodes 20 are determined. Hence, the first data-processing system 10 can be configured for this functionality, and the above-described method can be carried out several times.

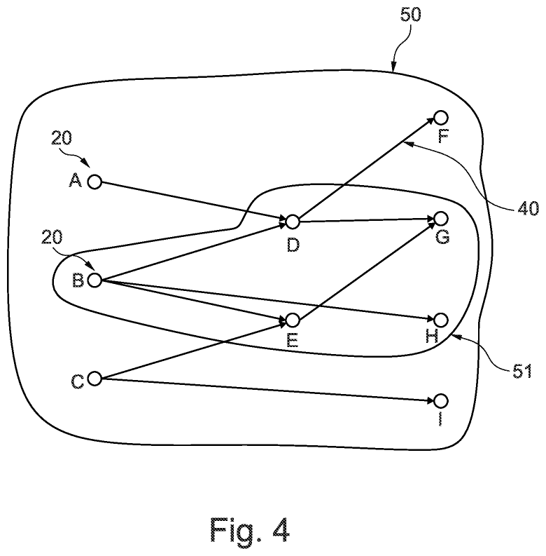

FIG. 4 shows an example for two subsets of the condition-nodes 50, 51, wherein the node-links 40 are the same. However, there could also be diverging subsets of node-links. The same applies to the condition-states 30, which are not shown in FIG. 4.

An example for an application of the method as shown in FIG. 3 and FIG. 4 can be an application for a production plant with a plurality of production systems, such as a plant for a set of mechanical products that are obtained for example by machining and heat treatment, wherein each type of product is produced by a separated manufacturing line. In such an example, each subset of condition nodes 50, 51, the respective second data-processing system 14, 15, the respective subset of the condition-states 52, 53, the respective subset of the node-links 54, 55 and the respectively stored values can correspond to a manufacturing line or to a part of the production plant that produces one product.

The condition-nodes 20 can in this case correspond to a reliability of parts of the system or respective functions.

The condition-nodes 20 can also refer to a risk of failure, a risk that a function cannot be performed and/or to other risks.

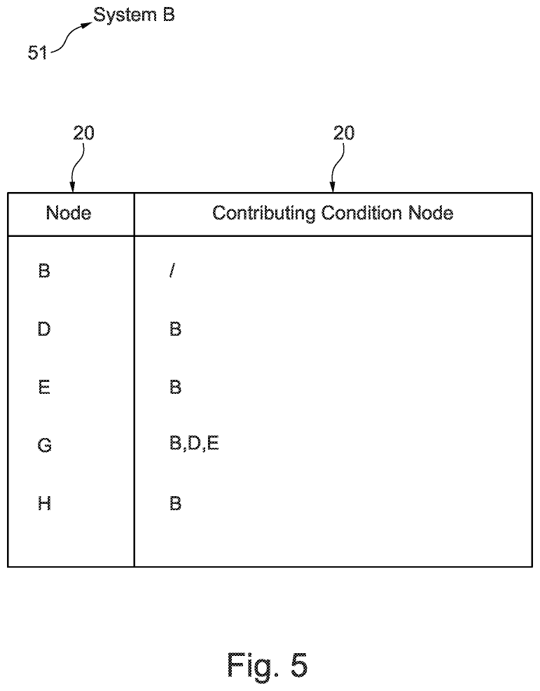

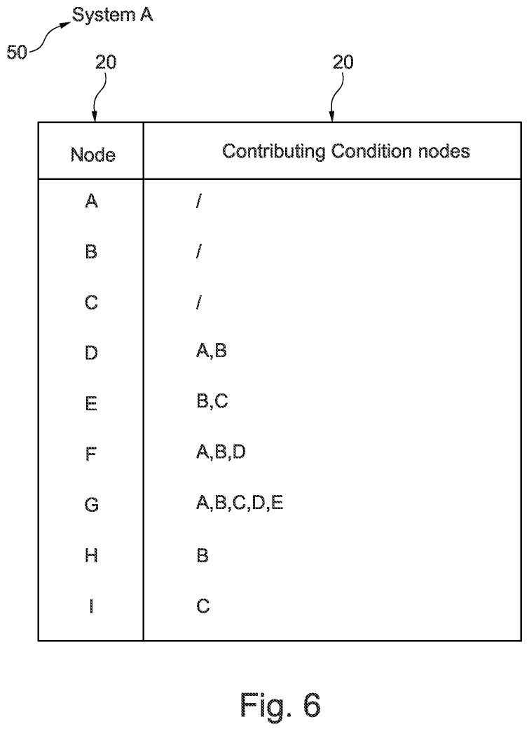

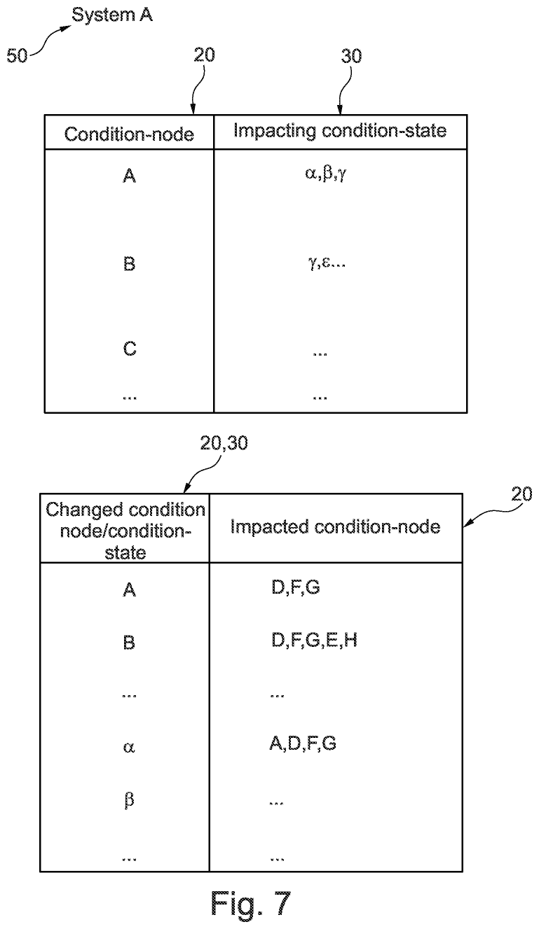

FIGS. 5, 6 and 7 show an example of pre-calculated data that can be pre-calculated by the first data-processing system. Pre-calculating data can decrease response times during runtime of an application reacting to user requests.

An example for such condition-nodes 20 can be “Risk of improper use of machine X”, “Risk of failures of machine X”, “Risk of unplanned stop of production of machine X” and “Risk of unplanned stop of production of production-line Y (comprising machine X)”, wherein these condition-nodes 20 can be linked by node-links 40 in the order in which they are named in this example. That is, a condition-node 20 referring to the risk of improper use of the machine X can be connected to a condition-node 20 referring to the risk of failure of the machine X, as improper use of the machine X may increase its risk of failure.

In said example, each of the second data-processing systems 14, 15 refers to all devices for data input and data output, such as devices used by maintenance personnel, maintenance engineers and machine operators to enable entry of condition-state values 36 or indicators thereof. Each of the second data-processing systems 14, 15 can optionally also comprise at least one interface to at least one other data-processing system, such as an interface to a data-processing system that controls or monitors a part of the respective production line.

Referring to a device used by a maintenance engineer who is in charge of the whole production facility, this device may be a part of a plurality of second data-processing systems 14, 15, wherein data referring to a first subset of condition-nodes, node-links and node-links are considered to be a part of a first second data-processing system and data referring to a second subset of condition-nodes, node-links and node-links are considered to be a part of a second second data-processing system.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used. While in the above, a preferred embodiment has been described with reference to the accompanying drawings, the skilled person will understand that this embodiment was provided for illustrative purpose only and should by no means be construed to limit the scope of the present invention, which is defined by the claims.

### NUMBERED REFERENCE SIGNS

10 first data-processing system

14, 15 second data-processing system

20 condition-node

22 condition-node modifier

24 condition-node value

30 condition-state

34 condition-state threshold

36 condition-state value

38 comparison result

40 node-links

42 node-link value

50, 51 subset of the condition-nodes

52, 53 subset of the condition-states

54, 55 subset of the node-links

60 processing component

62 condition-state determining component

64 condition-state processing component

66 condition-node processing component

68 input-processing component

70 output-determining component

72 limiting element

74 pre-calculating component

80 data-storage component

CSD condition-state determining step

CSP condition-state processing step

CNP condition-node processing step

CSS condition-state selecting step

CNS condition-node selecting step

CSV condition-state value receiving step

OS outputting step

NLS node-link selecting step

PCS pre-calculating step

1. A system, comprising a first data-processing system and at least one second data-processing system, a processing component and a data-storage component, wherein the system is configured to perform for each condition-state of at least a subset of condition states
comparing each condition-state value and a respective condition-state threshold,
thus generating a comparison result for each of these condition-states, and
further assigning each comparison result to the respective condition-state.

2. The system according to claim 1, wherein the processing component comprises a condition-state determining component and wherein the condition-state determining component is configured to perform for each condition-state of at least the subset of the condition states
comparing each condition-state value and the respective condition-state threshold,
thus generating a comparison result for each of these condition-states
further assigning the comparison result to the respective condition-state.

3. The system according to claim 1, wherein the processing component comprises a condition-state processing component, and wherein the condition-state processing component is configured for generating a condition-node modifier for each condition-node of at least a subset of condition-nodes by aggregating the comparison results of the condition-states of at least the subset of condition-nodes which condition-states are assigned to the respective condition-node.

4. The system according to claim 3, wherein the processing component comprises a condition-node processing component, and wherein the condition-node processing component is configured for generating a condition-node value for each condition-node of at least the subset of condition-nodes.

5. The system according to claim 1, wherein the system is configured for receiving input data that indicate at least a part or all of the condition-states of the subset(s) of the condition-states, and wherein the second data-processing system is configured to receive the input data that indicate at least a part or all of the condition-states of the subset(s) of the condition-states.

6. The system according to claim 3, wherein the system is configured for receiving input-data that indicate at least a part or all of the condition-nodes of the subset of the condition-nodes.

7. The system according to claim 6, wherein the input data that indicate at least a part or all of the condition-nodes of the subset(s) of the condition-states comprise the input data that indicate at least a part or all of the condition-states of the subset(s) of the condition-states, and wherein the system is configured for determining the subset(s) of the condition-nodes based on the input data that indicate at least a part or all of the condition-states of the subset(s) of the condition-states.

8. The system according to claim 1, wherein the system is configured for outputting data, and wherein the data to be outputted comprise at least one of condition-nodes and condition-states to be outputted that are each linked to at least one of a specified condition-node and a specified condition-state according to at least one of at least one or a plurality of linking criteria.

9. A computer-implemented method, comprising
using at least one of a first data-processing system and a second data-processing system to perform the method,
storing a plurality of the condition-nodes and at least one condition-state, wherein each condition-state is assigned to at least one condition-node, and wherein each condition-state comprises
a condition-state threshold and
a condition-state value
storing at least one node-link(s), wherein each node-link connects two condition-nodes and each node-link is directed,
a condition-state determining step, comprising for each condition-state of at least a subset of the condition-states
comparing the respective condition-state value and the respective condition-state threshold and thus generating a respective comparison result, and
assigning the comparison result to the respective condition-state
a condition-state processing step, comprising for each condition-node of the subset of the condition nodes aggregating the comparison results of the condition-states of the subset of the condition-states relating to the respective condition-node and thus generating a condition-node modifier for the respective condition-node.

10. The method according to claim 9, wherein comparing the respective condition-state value and the respective condition-state threshold and thus generating a respective comparison result comprises calculating a distance of the respective condition-state value and the respective condition-state threshold.

11. The method according to claim 9, wherein the step of generating the condition-node value for each condition-node of at least the subset of the condition-nodes comprises combining
the condition-node modifier of the respective condition-node, and
the condition-node value of each condition-node of the subset of the condition-nodes that is linked to the respective condition-node by a node-link that is directed towards the respective condition-node.

12. The method according to claim 9, wherein the method further comprises a condition-state selecting step, wherein the condition-state selecting step comprises receiving input data that indicate at least a part or all of the condition-states of the subset of the condition-states.

13. The method according to claim 9, wherein the method further comprises a condition-node selecting step, wherein the condition-node selecting step comprises receiving input data that indicate at least a part or all of the condition-nodes of the subset of the condition-nodes.

14. The method according to claim 12, wherein the method wherein the condition-node selecting step further comprises selecting condition-nodes based on the input data that indicate at least a part or all of the condition-states of the subset of the condition-states.

15. The method according to claim 9, wherein the method further comprises an outputting step that comprises outputting data, and wherein in the outputting step, the outputting data comprises outputting at least one of condition-nodes and condition-states to be outputted that are each linked to at least one of a specified condition-node and a specified condition-state according to a linking-criterion.

16. A computer program comprising instructions causing the system according to claim 1 to execute steps of the method comprising:
using at least one of a first data-processing system and a second data-processing system to perform the method,
storing a plurality of the condition-nodes and at least one condition-state,
wherein each condition-state is assigned to at least one condition-node, and wherein each condition-state comprises
a condition-state threshold and
a condition-state value
storing at least one node-link(s), wherein each node-link connects two condition-nodes and each node-link is directed,
a condition-state determining step, comprising for each condition-state of at least a subset of the condition-states
comparing the respective condition-state value and the respective condition-state threshold and thus generating a respective comparison result and
assigning the comparison result to the respective condition-state
a condition-state processing step, comprising for each condition-node of the subset of the condition nodes aggregating the comparison results of the condition-states of the subset of the condition-states relating to the respective condition-node and thus generating a condition-node modifier for the respective condition-node.
